(19) United States
(12) Patent Application Publication
(10) Pub. No.: US 2014/0092596 A1
(43) Pub. Date: Apr. 3, 2014

(54) DIMMABLE, HIGH-EFFICIENCY LED LINEAR LIGHTING SYSTEM WITH INTERCHANGEABLE FEATURES AND METHODS FOR PRODUCING SAME

(71) Applicant: Linear Lighting Corp., Long Island City, NY (US)

(72) Inventors: Lawrence Adam Deutsch, Bedford, NY (US); Richard J. Coffin, Amenia, NY (US); Arkady Orlov, Staten Island, NY (US)

(73) Assignee: Linear Lighting Corp., Long Island City, NY (US)

(21) Appl. No.: 14/042,238

(22) Filed: Sep. 30, 2013

Related U.S. Application Data
(60) Provisional application No. 61/707,771, filed on Sep. 28, 2012.

(51) Int. Cl. F21K 99/00; F21V 29/00

(52) U.S. Cl. CPC F21K 9/50; F21V 29/22
USPC 362/236; 362/235

(57) ABSTRACT

A light source is provided including a heat sink and a printed circuit board (PCB) with a driver and lamps disposed in the central cavity of the heat sink. Each lamp is a semi-spherical solid state lamp, and multiple optical structures in operable registration with lamps. The PCB may further have two heat conducting strips proximate opposing edges of the PCB. The optical structures emit substantially shadowless, substantially homogeneous, and substantially monochromatic light. The optical structure includes an optical element for each lamp that substantially collimates the lamp's light and an optical element receiving a portion of the substantially collimated beam and provides multiple optical images of the collimated beam with a focal point that is practically infinite.

This application claims priority to U.S. Provisional Patent Application No. 61/707,771, filed Sep. 28, 2012, which is incorporated by reference in its entirety.

### BACKGROUND

1. Field of the Invention

The present invention relates to light sources, and more particularly to solid state light sources.

2. Description of the Related Art

Electric light sources have been used for almost two hundred years to illuminate spaces such homes, offices, and exterior spaces. Light sources commonly include components such as: a light fixture, a housing, a driver circuit, a lamp, and a lens. A single light source may have multiple light fixtures, housings, driver circuits, lamps, and lenses.

Light fixtures are commonly designed to enclose a housing, lamp, and lens. The light fixture may contain dedicated space for electrical wiring. For instance, a suspended light fixture may contain a hollow pole for electrical wiring to connect the lamp and an outside source of power. Light sources are frequently installed on walls or ceilings or suspended from ceilings. Several light sources may be electrically and/or mechanically connected. Light sources are also frequently installed in free standing table or floor lamps. In particular, fluorescent lights are often used in light sources, placed end-to-end, in order to light hallways, large rooms, and other spaces. The housing for a light source may be visible, installed in a base, such as an Edison base, or may be recessed within a ceiling or wall.

Light fixtures may be constructed to provide different types of lighting effects such as downlights, uplights, wall washers, and grazers. These effects may be provided by a variety of fixture types such as cove lights, pendant lights, recessed lights, and sconces. Multiple light fixtures may be mechanically coupled together. Light fixtures that have been mechanically coupled together may consist of multiples of the same fixture, or a variety of different fixtures. However, in the prior art when fluorescent-based light sources were coupled together, for example, they suffered from the drawback of requiring a break in the light to accommodate ballasts, wiring, and other necessary hardware components.

Light fixtures contain one or more sources of illumination, i.e., lamps. Incandescent, fluorescent, high-intensity discharge, and more recently light emitting diodes (LEDs), among other types of illuminating components, are used within a light fixture as the lamp. Electrically speaking, the light emitting portion of the light source may be referred to as the load.

Optical structures are often used to enhance, direct, and otherwise alter the light emitted from the lamp. One such effect is microdiffusion. Current techniques of creating microdiffusion for lenses include creating a microdiffusion surface on a film through processes such as photolithography and photoengraving. Such films are then applied to other optical structures to diffuse light emitted from the light source.

### BRIEF SUMMARY OF THE INVENTION

The disclosed subject matter relates to a light source. The light source includes a heat sink including a central cavity and at least one wall enclosing a portion of the central cavity; a printed circuit board (PCB) disposed in the central cavity of the heat sink, the PCB having a driver circuit disposed on a first side of the PCB and a plurality of lamps substantially surface-mounted on an opposing side of the PCB, wherein the plurality of lamps are operably connected to the driver circuit, wherein each of the plurality of lamps is a semi-spherical solid state lamp, the PCB further having a connector that can be operably connected to a power source; and a first optical structure in operable registration with at least one of the plurality of lamps.

The light source may further include an optical structure for a plurality of lamps, wherein each lamp is a semi-spherical solid state lamp, wherein the optical structure emits substantially shadowless, substantially homogeneous, and substantially monochromatic light, the optical structure including: a plurality of first optical elements, each associated with one of the plurality of lamps for substantially collimating the light emitted from the associated one of the plurality of lamps to form a substantially collimated beam; and a second optical element associated with each of the plurality of first optical elements such that each of the plurality of second optical elements receives a portion of the substantially collimated beam and provides multiple optical images of the collimated beam, wherein the focal point of each of the multiple optical images formed by the plurality of second optical elements have a focal point that is practically infinite.

The subject matter of the invention further regards a light source with an optical structure including an inner surface, an outer surface, and a body disposed between the inner and outer surfaces, wherein the inner surface is disposed toward a plurality of lamps, wherein each lamp is a semi-spherical solid state lamp; a plurality of first optical elements each having a column shaped cavity extending into the body from the inner surface, the column shaped cavity terminating in a convex surface, the opposite distal end of each column shaped cavity being operably associated with a respective one of the plurality of lamps; and a second optical element for each of the plurality of first optical elements, each second optical element including a plurality of protrusions having a substantially hexagonal base and a spherical cap, wherein each second optical element abuts at least two other second optical element, where the microdiffusion texture may be configured to create a five degree spread and is created in the outer surface of the optical structure via an injection mold process.

The light source may include a third optical element including a microdiffusion texture formed in the outer surface of the optical structure. The microdiffusion texture may be configured to create a five degree spread. The microdiffusion texture is created in the outer surface of the optical structure via an injection mold process. The optical structure may have a microdiffusion texture that is based on fractal geometry. The optical structure may further include multiple protrusions for each of the second optical elements each including twelve facets. Each of the plurality of lamps of the light source may include a light-emitting diode. The plurality of lamps be either three lamps or six lamps. The first optical element may collimate the light of each lamp to a fixed diameter.

The disclosed subject matter further includes an optical structure including an inner surface, an outer surface, and a body disposed between the inner surface and the outer surface, wherein the inner surface is proximate to a plurality of lamps wherein each lamp is a semi-spherical solid state lamp and wherein the plurality of lamps are linearly arranged; a first optical element having a cavity extending into the body from a rectangular opening of the inner surface having a concave surface facing the inner surface for each of the plurality of lamps; and a second optical element including a plurality of total internal reflection (TIR) elements formed on the outer surface extending along a length of the outer surface across the plurality of lamps.

The optical structure may further include a second optical structure separated from the first optical structure by a fixed distance, the second optical structure having a first side, a second side, and a body disposed between the first side and the second side, wherein the first side is proximate to the plurality of lamps; a third optical element disposed in a portion of the first side of the second optical structure directing light from the plurality of lamps to a fixed degree of spread; and a fourth optical element including a microdiffusion texture formed in the second side of the second optical structure. The optical structure may include a microdiffusion pattern configured to create a five degree spread. The microdiffusion pattern may be created in the second side of the second optical structure via a roller press. The optical structure may include the fixed degree of spread as one of ten degrees, thirty degrees, forty-five degrees, sixty degrees, or one hundred twenty degrees. The optical structure may include the plurality of TIR elements of the second optical element that are shaped such that exiting light is evenly spread to an angle corresponding to a width of the second optical structure at the fixed distance from the first optical structure. The second optical structure may be formed by an extrusion process.

The subject matter of the disclosure further includes a light source including a housing; a lamp disposed within the housing, wherein the lamp load is a semi-spherical solid state lamp presenting a lamp load to a driver circuit; and the driver circuit disposed within the housing operatively connected to the lamp load, the driver circuit including an alternating current (AC) to direct current (DC) power converter circuit receiving input power having a duty cycle from a power supply and outputting a DC power output including a ripple voltage having a magnitude that is ratiometrically determined by the duty cycle and the lamp load; a peak detector circuit receiving the DC power output from the AC to DC power converter circuit and removing a DC offset; and a constant current circuit receiving the output of the peak detector circuit and the current through the lamp load and varying the current delivered by the constant current circuit to the lamp load based on the ripple component.

The light source may further include the output of the peak detector circuit as an average of the DC power output from the AC to DC power converter over a plurality of duty cycles of the input power. The constant current circuit of the light source may reduce the current delivered to the lamp load when the average output of the peak detector circuit falls below a threshold voltage. The duty cycle of the input power of the light source may be influenced by one of a triode for alternating current (TRIAC) and a silicone control rectifier (SCR). The light source may further include an optical structure disposed within the housing. The optical structure of the light source may be formed by injection molding and wherein the optical structure includes an optical element comprising a microdiffusion pattern molded directly onto a surface of the optical structure. The light source may include an Edison-type base.

The subject matter of the disclosure further regards a driver circuit for a light source including a lamp, wherein the lamp comprises a semi-spherical solid state lamp and presents a lamp load to the driver circuit, the driver circuit including an alternating current (AC) to direct current (DC) power converter circuit receiving input power having a duty cycle from a power supply and outputting a DC power output including a ripple voltage having a magnitude that is ratiometrically determined by the duty cycle and the lamp load; a peak detector circuit receiving the DC power output from the AC to DC power converter circuit and removing a DC offset; and a constant current circuit receiving the output of the peak detector circuit and the current through the lamp load and varying the current delivered by the constant current circuit to the lamp load based on the ripple component.

The driver circuit of the light source may have the output of the peak detector circuit as an average of the DC power output from the AC to DC power converter over a plurality of duty cycles of the input power. The constant current circuit may reduce the current delivered to the lamp load when the average output of the peak detector circuit falls below a threshold voltage. The duty cycle of the input power may be influenced by one of a triode for alternating current (TRIAC) and a silicone control rectifier (SCR).

The subject matter of the disclosure further includes a driver circuit for a light source including a plurality lamps, wherein each lamp comprises a semi-spherical solid state lamp presenting a lamp load to the driver circuit, the driver circuit including an alternating current (AC) to direct current (DC) power converter circuit receiving input power having a duty cycle from a power supply and outputting a DC power output including a ripple voltage having a magnitude that is ratiometrically determined by the duty cycle and the lamp load; a peak detector circuit receiving the DC power output from the AC to DC power converter circuit and removing a DC offset; and a constant current circuit receiving the output of the peak detector circuit and the current through the plurality of lamp loads and varying the current delivered by the constant current circuit to the plurality of lamp loads based on the ripple component.

The driver circuit may include the output of the peak detector circuit as an average of the DC power output from the AC to DC power converter over a plurality of duty cycles of the input power. The constant current circuit may reduce the current delivered to the lamp load when the average output of the peak detector circuit falls below a threshold voltage. The duty cycle of the input power is influenced by one of a triode for alternating current (TRIAC) and a silicone control rectifier (SCR).

The subject matter of the disclosure further regards a light source including a plurality of lamps, wherein each lamp comprises a semi-spherical solid state lamp, the light source including a heat sink including a central cavity and at least one wall enclosing a portion of the central cavity; a printed circuit board (PCB) disposed in the central cavity of the heat sink, the PCB having a driver circuit disposed on a first side of the PCB and a plurality of lamps substantially surface-mounted on an opposing side of the PCB, each of the plurality of lamps operatively connected with the driver circuit so as to present a lamp load to the driver circuit, the PCB further having a connector that can be operably connected to a power source, wherein the driver circuit includes an alternating current (AC) to direct current (DC) power converter circuit receiving input power from a power supply and outputting a DC power output; a dimming control circuit receiving input power having a duty cycle and a maximum output power value and outputting a dim control signal based on the duty cycle of the input power and the maximum output power value; and a constant current circuit receiving the dim control signal and feedback based on the current through the plurality of lamp loads and varying the current delivered by the constant current circuit to the plurality of lamp loads based on the dim control signal; and a first optical structure in operable registration with at least one of the plurality of lamps.

The dim control signal of the light source may be limited by the maximum output power and further limited by the duty cycle of the input power. The feedback may be further limited by a maximum power output limit. The light source may be electrically connected to a second driver circuit wherein the current delivered by each of the constant current circuits is based on the dim control signal of the driver circuit determined to be a master driver circuit. The PCB may include at least one frangible section, each frangible section having at least one of the plurality of lamp loads substantially surface-mounted thereon and a pre-perforated border to facilitate breakaway of the frangible section from the PCB while allowing operable electrical connection between the at least one of the plurality of lamp loads and the driver circuit via a solid-state switch, the gate of the solid-state switch being biased into conduction by the voltage across the at least one of the plurality of lamp loads disposed on the frangible section. The number of lamp loads connected to the driver circuit of the light source may be variable, wherein the last of the plurality of lamp loads is operably connected to the driver circuit via a solid-state switch forward biased by a voltage drop across one of the plurality of lamp load.

The subject matter of the disclosure includes a driver circuit for a light source including a plurality of lamps, wherein each lamp comprises a semi-spherical solid state lamp presenting a lamp load to the driver circuit, the driver circuit comprising an alternating current (AC) to direct current (DC) power converter circuit receiving input power from a power supply and outputting a DC power output; a dimming control circuit receiving input power having a duty cycle and a maximum output power value and outputting a dim control signal based on the duty cycle of the input power and the maximum output power value; and a constant current circuit receiving the dim control signal and feedback based on the current through the plurality of lamp loads, the constant current circuit varying the current delivered by the constant current circuit to the plurality of lamp loads based on the dim control signal.

The dim control signal of the driver circuit may be limited by the maximum output power and further limited by the duty cycle of the input power. The feedback of the driver circuit may be further limited by a maximum power output limit. The driver circuit may be electrically connected to a second driver circuit. The current delivered by each of the constant current circuits is based on the dim control signal of the driver circuit determined to be a master driver circuit. The PCB of the light source may include at least one frangible section, each frangible section having at least one of the plurality of lamp loads substantially surface-mounted thereon and a pre-perforated border to facilitate breakaway of the frangible section from the PCB while allowing operable electrical connection between the at least one of the plurality of lamp loads and the driver circuit via a solid-state switch, the gate of the solid-state switch being biased into conduction by the voltage across the at least one of the plurality of lamp loads disposed on the frangible section. The number of lamp loads of the light source of the plurality of lamp loads connected to the driver is variable, wherein the last of the plurality of lamp loads is operably connected to the driver circuit via a solid-state switch forward biased by a voltage drop across one of the plurality of lamp loads. The number of lamp loads of the plurality of lamp loads connected to the driver of the light source may be variable, wherein the last of the plurality of lamp loads is operably connected to the driver circuit via a solid-state switch forward biased by a voltage drop across one of the plurality of lamp loads.

The subject matter of the disclosure further regards a method for providing a light source of flexible length including a plurality of lamps, wherein each lamp comprises a semi-spherical solid state lamp, the method including providing a heat sink including a central cavity and at least one wall enclosing a portion of the central cavity; providing a printed circuit board (PCB) disposed in the central cavity of the heat sink, the PCB having a driver circuit disposed on a first side of the PCB, the PCB having a plurality of lamps substantially surface-mounted on an opposing side of the PCB, the PCB having an alterable length such that the length is determined by breaking off the PCB at increments, wherein each increment includes at least one of the plurality of lamps, each of the plurality of lamps operatively connected with the driver circuit so as to present a lamp load to the driver circuit, the PCB further having a connector that can be operably connected to a power source, wherein the driver circuit includes an alternating current (AC) to direct current (DC) power converter circuit receiving input power from a power supply and outputting a DC power output; a dimming control circuit receiving input power having a duty cycle and a maximum output power value and outputting a dim control signal based on the duty cycle of the input power and the maximum output power value; and a constant current circuit receiving the dim control signal and the current across the plurality of lamp loads and varying the current delivered by the constant current circuit to the plurality of lamp loads based on the dim control signal; and providing a first optical structure in operable registration with at least one of the plurality of lamps.

The dim control signal of the method may be limited by the maximum output power and further limited by the duty cycle of the input power. The feedback may be further limited by a maximum power output limit. The method may additionally include providing an electrical connection to a second driver circuit. The current delivered by each of the constant current circuits in the method may be based on the dim control signal of the driver circuit determined to be a master driver circuit. The method may include a the lamp load nearest the broken end of the PCB that is operably connected to the driver circuit via a solid-state switch forward biased by a voltage drop across one of the plurality of lamp loads.

These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

### BRIEF DESCRIPTION OF THE FIGURES

FIG. 1 is a perspective view of a room 10 containing several light sources of the subject technology.

FIG. 2A is a cross-section of the light fixture 115 of FIG.1.

FIG. 2B is a cross-section of another light fixture in accordance with the subject technology.

FIG. 2C is a cross-section of yet another light fixture in accordance with the subject technology.

FIG. 3A is a perspective view of a heat sink 300 that may comprise all or a portion of a heat sink for the light sources illustrated in FIGS. 1 and 2A-2C in accordance with the subject technology.

FIG. 3B is a perspective view of two heat sinks 300 that have been joined together in accordance with the subject technology.

FIG. 3C-3F are detailed, perspective views of exemplary connectors that may be used in association with the heat sinks of FIG. 3B in accordance with the subject technology.

FIG. 4A-4D are cross-sectional views of additional embodiments of a heat sink for use in light sources in accordance with the subject technology.

FIG. 4E-4K are cross-sectional views of additional embodiments of a dual sided heat sink for use in light sources in accordance with the subject technology.

FIG. 5 is a cross-sectional view of any one of the heat sinks of FIGS. 3A-3D with a printed circuit board (PCB) and first and second optical structures associated therewith in accordance with the subject technology.

FIG. 6A is a bottom plan view of the first optical structure 550 illustrated in FIG. 5.

FIG. 6B is a longitudinal cross-sectional illustration of the first optical structure of FIG. 6A.

FIG. 6C is a detailed view of a portion of the first optical structure as illustrated in FIG. 6A by legend “6C”.

FIG. 6D is a perspective view of the first optical structure of FIG. 6A.

FIG. 6E-6F are cross-sectional views of the first optical structure of FIG. 6A taken across sight lines 6E and 6F in FIG. 6D.

FIG. 6G is a flow chart illustrating a method for making the first optical structure of the type illustrated in FIGS. 5 and 6A-6F.

FIG. 7A is a perspective view of a second optical structure 700 in accordance with the subject technology.

FIG. 7B is a flow chart illustrating a method for making the second optical structure of the type illustrated in FIGS. 5 and 7A.

FIGS. 8A-8I are elevational end views illustrating one set of potential embodiments of the potential varieties of the type of second optical structure illustrated in FIG. 7A.

FIG. 9A is a front plan view of a first PAR optical structure in accordance with the subject technology.

FIG. 9B is a perspective view of the optical structure of FIG. 9A.

FIG. 9C is a perspective view of the back of the optical structure of FIG. 9A.

FIG. 9D is a front view of mounted lamps for use with the optical structure of FIG. 9A in accordance with the subject technology.

FIG. 9E is a perspective view of the mounted lamps of FIG. 9D illustrating the connection to a driver circuit in accordance with the subject technology.

FIG. 10A is a front plan view of a second PAR optical structure in accordance with the subject technology.

FIG. 10B is a perspective view of the optical structure of FIG. 10A.

FIG. 10C is a perspective view of the back of the optical structure of FIG. 10A.

FIG. 10D is another perspective view of the optical structure of 10A providing further illustration of the detail on the outer surface of the optical structure.

FIG. 10E is a cross-section of the protrusions 1050 of FIG. 10D.

FIG. 11A is a front plan view of a third PAR optical structure in accordance with the subject technology.

FIG. 11B is a perspective view of the optical structure of FIG. 11A.

FIG. 11C is a perspective view of the back of the optical structure of FIG. 11A.

FIG. 12A is a flow chart illustrating a method for making the types of PAR optical structures illustrated in FIGS. 9A-11C.

FIG. 12B-C is a schematic diagram of a driver circuit for use with some embodiments of the subject technology.

FIG. 13 is a perspective view of one potential housing for use with PAR optical structures such as those illustrated in FIGS. 9-11 in accordance with the subject technology.

FIG. 14A is a top plan view of PCB 520 of FIG. 5 illustrating a driver circuit in accordance with the subject technology.

FIG. 14B is a perspective view of two PCBs 520 that have been joined together in accordance with the subject technology.

FIG. 14C is a bottom plan view of PCB 520 illustrating a layout of lamps disposed in PCB 520 in accordance with the subject technology.

FIG. 14D is a bottom plan view of another embodiment of a PCB of alterable length in accordance with the subject technology.

FIG. 14E is a bottom plan view of the alterable length PCB of FIG. 14D after reducing the length of the PCB in accordance with the subject technology.

FIG. 15 is a schematic diagram of driver circuit 1500 for use with some embodiments of the subject technology particularly where dimming of the light source must be controlled directly by the source voltage.

FIGS. 16A and 16B together form a schematic diagram of driver circuit 1600 for use with other embodiments of the subject technology.

FIG. 17 is a schematic diagram depicting the electrical operation of the frangible PCB embodiment.

FIGS. 18-20D are schematic diagrams depicting additional embodiments of driver circuits for use with some embodiments of the subject technology.

FIG. 21 illustrates voltage waveforms of the circuit of FIG. 12C.

While the present disclosure may be embodied in many different forms, the drawings and discussions are presented with the understanding that the present disclosure is an exemplification of the principles of one or more inventions and is not intended to limit any one of the inventions to the embodiments illustrated. It is understood that the specific order or hierarchy of steps in disclosed methods and processes may be rearranged. Steps may be performed simultaneously or all disclosed steps may not be performed without departing from the scope of the subject technology.

### DETAILED DESCRIPTION OF THE INVENTION

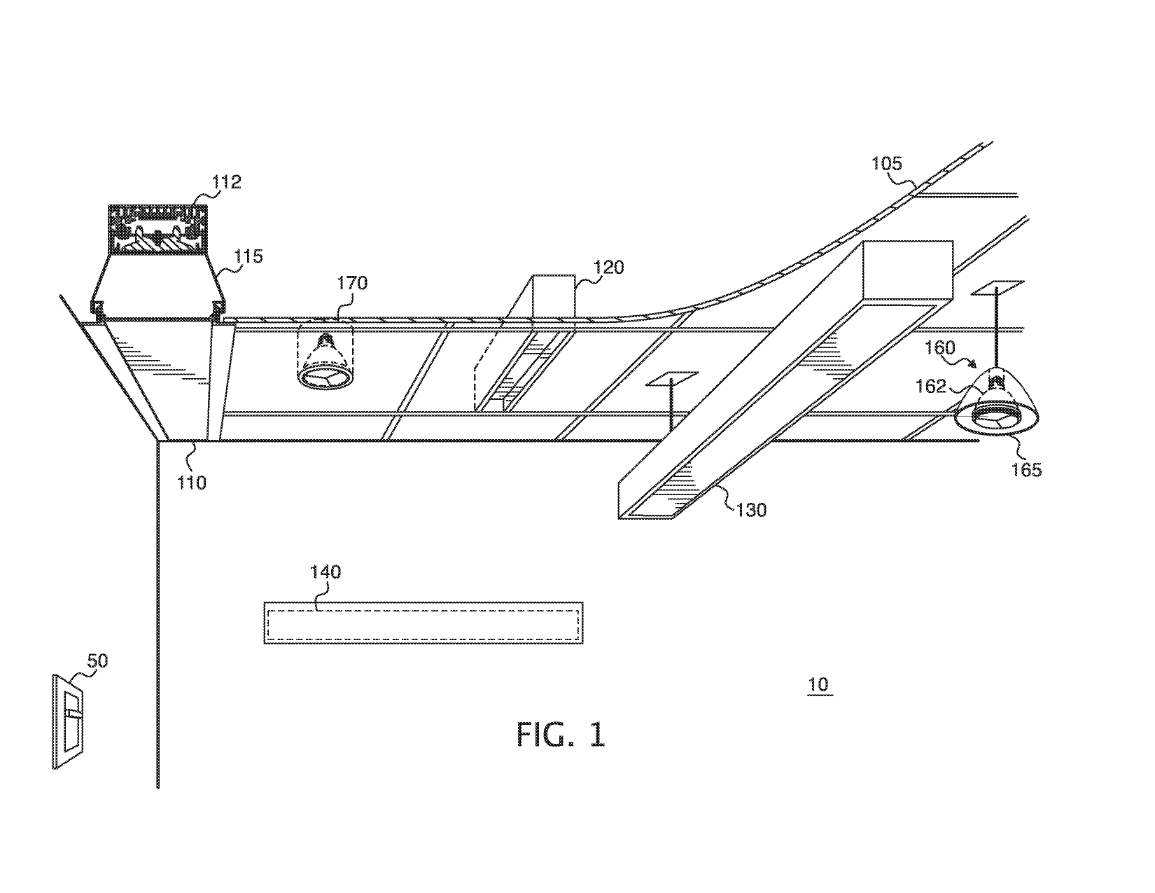

FIG. 1 is a perspective view of a room 10 containing several light sources of the subject technology. Room 10 may be thought of as an office displaying a variety of lighting sources to illustrate the potential diversity supported by the subject technology. As shown in FIG. 1, room 10 may also contain a dimmer 50. Dimmer 50 may control one or more of the light sources in the room 10. Dimmer 50 may be any type of thyristor-based dimmer (as commonly known in the art), which is used to adjust the intensity of the illumination in room 10. As will be described herein below, the light source of the subject technology are capable of operating properly with a broad range of thyristor dimmers, unlike most prior art systems that guarantee operation with one or two commonly used dimming circuits.

FIG. 1 illustrates a first recessed mounted light source 110, second recessed mounted light source 120, pendant mounted light source 130, wall mounted light source 140, pendant light 160, and recessed can light 170. This variety of light sources is meant to illustrate that any number of light sources may be supported by the subject technology. As further illustrated in FIG. 1, recessed mounted light source 110 may be installed in a ceiling 105 near a wall of room 10 to produce a grazer effect on that near wall. As will be discussed below, optical structures may be installed within light source 110 to create a variety of lighting effects—aside from wall grazing—thus providing each light source with a large degree of flexibility for architects and designers. Pendant light 160 includes light fixture 165 and housing 162. Recessed can light 170 is constructed such that the housing 162 of pendant light 160 may be interchangeably used.

Light source 110 includes light fixture 115 and heat sink 112. In a preferred approach to the lighting system for deployment in room 10, light sources 120, 130, and 140 are designed around heat sinks that are substantially identical to heat sink 112. By creating a line of light sources that have common sub-components, like heat sink 112, the potential complexity in assembling multiple types of light sources as well as the component inventory may be substantially reduced. In addition to interchangeable heat sink 112, light sources may include other common sub-components such as optical structures and driver circuitry on printed circuit boards (PCBs). In a similar vein, the heat sink 112 as well as optical structures and PCBs may be comprised of multiple components in a modular assembly to accommodate a variety of desired fixture lengths leading to even further room design flexibility. Interchangeability of components additionally provides efficient and streamlined upgradeability of components such as driver circuits contained on PCBs. Thus, upgrades in driver circuitry or other changes to the light sources after installation may be performed by interchanging parts without the aid of a skilled technician.

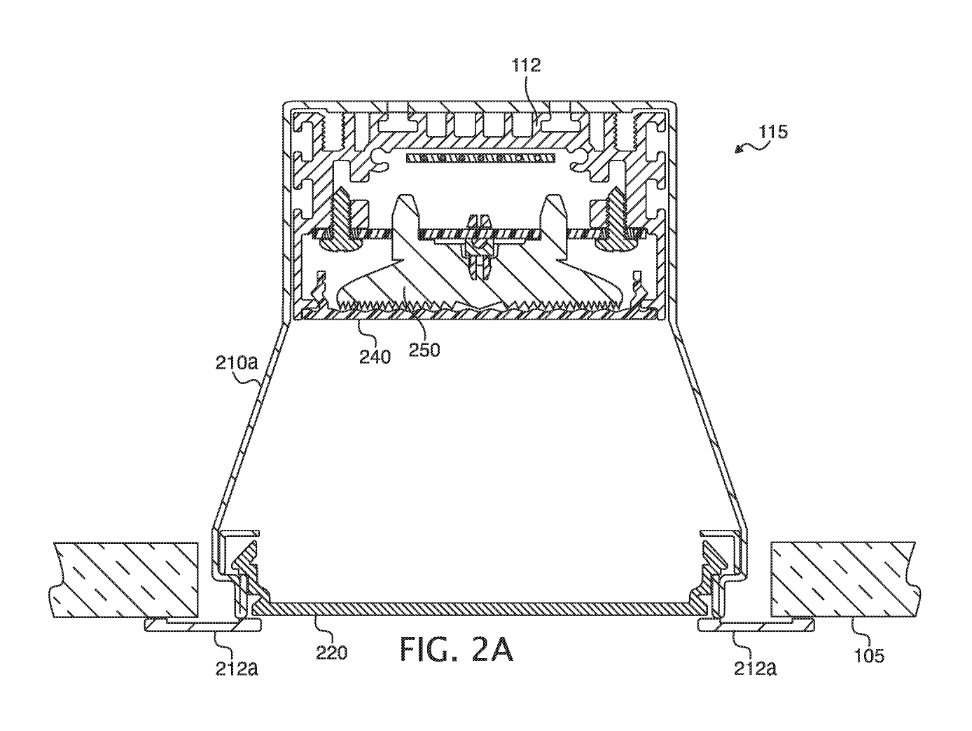

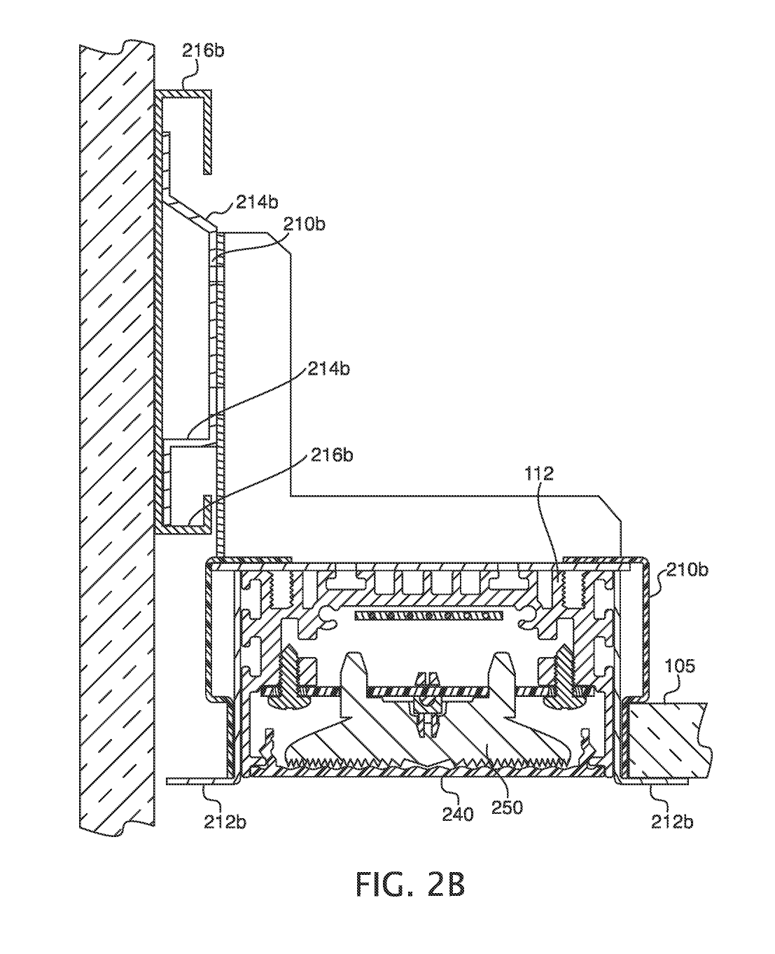

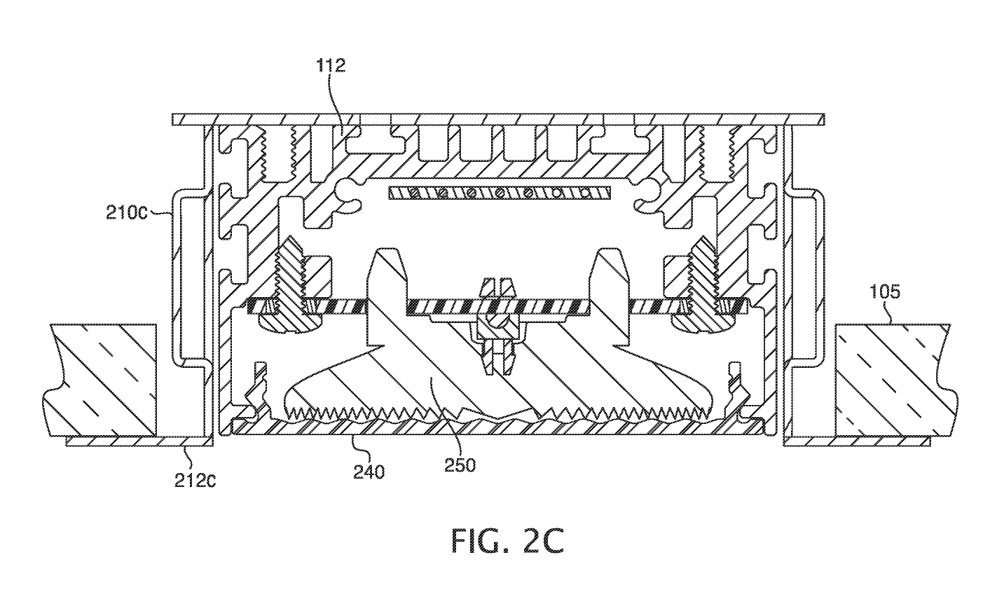

FIG. 2A is a cross-section of the light fixture 115 of FIG. 1. Light fixture 115 includes light fixture 210a and heat sink 112. The term “light fixture” as used herein encompasses its plain and ordinary meaning, including, but not limited to, one or more structures covering substantial portions of the light source, such as its one or more of electrical components and one or more heat sinks. A light fixture may be shaped to provide an aesthetically pleasing component and may additionally provide a mechanical structure with which to affix a light source to a wall, ceiling, or other structure. The light fixture may include portions that facilitate connection of internal electrical components to an external power source.

Light fixture 210a of FIG. 2A may be removably or permanently secured to ceiling 105 using any combination or variety of known supportive brackets and/or fasteners. For example, the light fixture 210a may be installed with “L” shaped brackets attached to portions of light fixture 115. Fixture 210a may additionally include a portion 212a contacting exterior portions of ceiling 105 for aesthetic and structural reasons. Portion 212a may serve as a transition between the ceiling 105 and an optical structure 220.

As shown in FIG. 2A, light source 115 may also preferably include first and second optical structures 240 and 250, respectively. The term “optical structure” as used herein encompasses its plain and ordinary meaning, including, but not limited to, a physical lens structure (including lens structures that provides an optical effect including concentrating or dispersing light rays). A single optical structure may contain multiple optical elements. One optical structure may be intended to be used with additional optical structures to produce a desired result. An optical structure may use an air cavity or air gap of a fixed volume or distance in order to produce the desired effect. Multiple optical structures with different optical elements may be used together to produce the desired optical effect.

FIG. 2B is a cross-section of a light fixture of a light source in accordance with the subject technology. The light fixture of 2B may be constructed using the first and second optical structures 240 and 250 in addition to the heat sink 112. Components contained within the heat sink 112 may be identical to components contained in light sources illustrated in FIGS. 1 and 2A. In the exemplary embodiment of the subject technology of FIG. 2B, light fixture 210b may additionally include a portion 212b contacting exterior portions of ceiling 105 for aesthetic and structural reasons. Portion 212b may serve as a transition between the ceiling 105 and an optical structure 240. Light fixture 210b includes portion 216b that is first installed on a wall using any type of fastener. Portions of the light fixture 214b may then be fitted into light fixture portion 216b such that the light source of FIG. 2B requires no external support while applying multiple additional fasteners to secure light fixture portion 214b to light fixture portion 216b down the entire length of light source of FIG. 2B. The use of light fixture portions 214b and 216b allow a single person to install light source of FIG. 2B without providing any additional support for the light source of FIG. 2B during the installation process. Variations of light fixture 210b may be created in order to hang the fixture lower on a wall without physically contacting ceiling 105.

In the exemplary embodiment of the subject invention of FIG. 2B, the light fixture 210 may be removably or permanently secured to ceiling 105 using any combination or variety of supportive brackets and/or fasteners. Light fixture 210c may additionally include a portion 212c contacting exterior portions of ceiling 105 for aesthetic and structural reasons. Portion 212c may serve as a transition between the ceiling 105 and an optical structure 240.

FIG. 2C is a cross-section of a light fixture of a light source in accordance with the subject technology. The light fixture of 2C may be constructed using the same first and second optical structures 240 and 250 in addition to the heat sink 112. Components contained within heat sink 112 may be identical to components contained in light sources of FIGS. 2A and 2B.

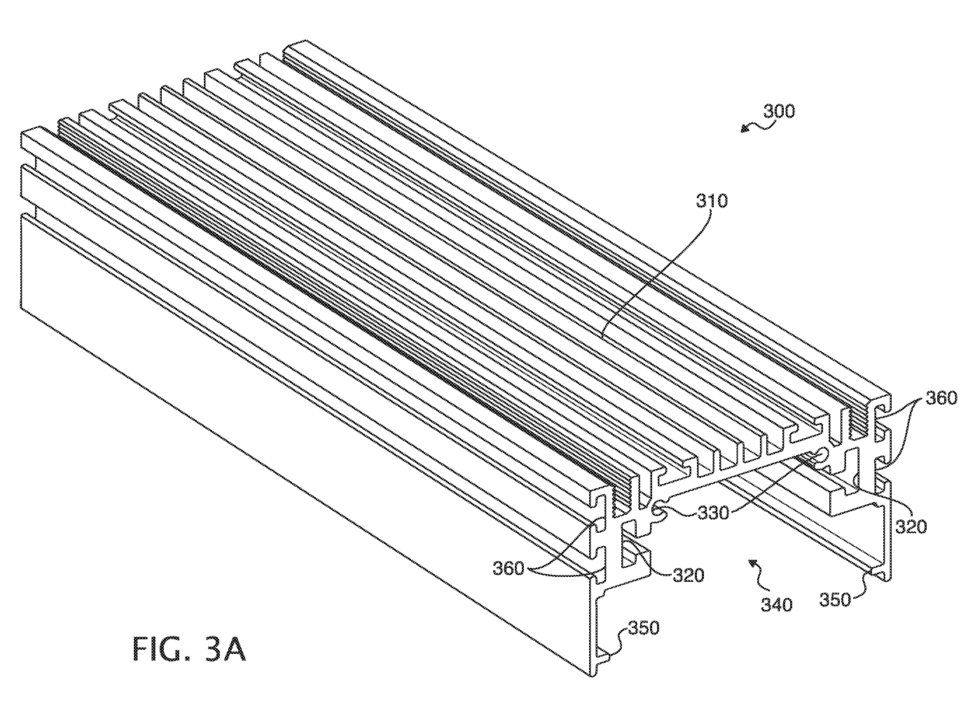

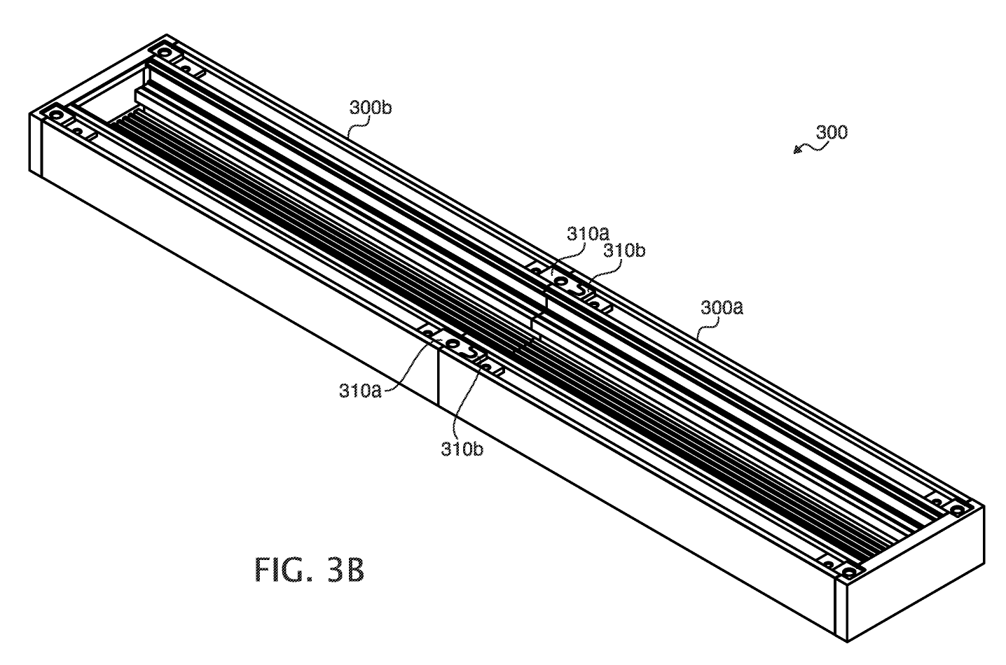

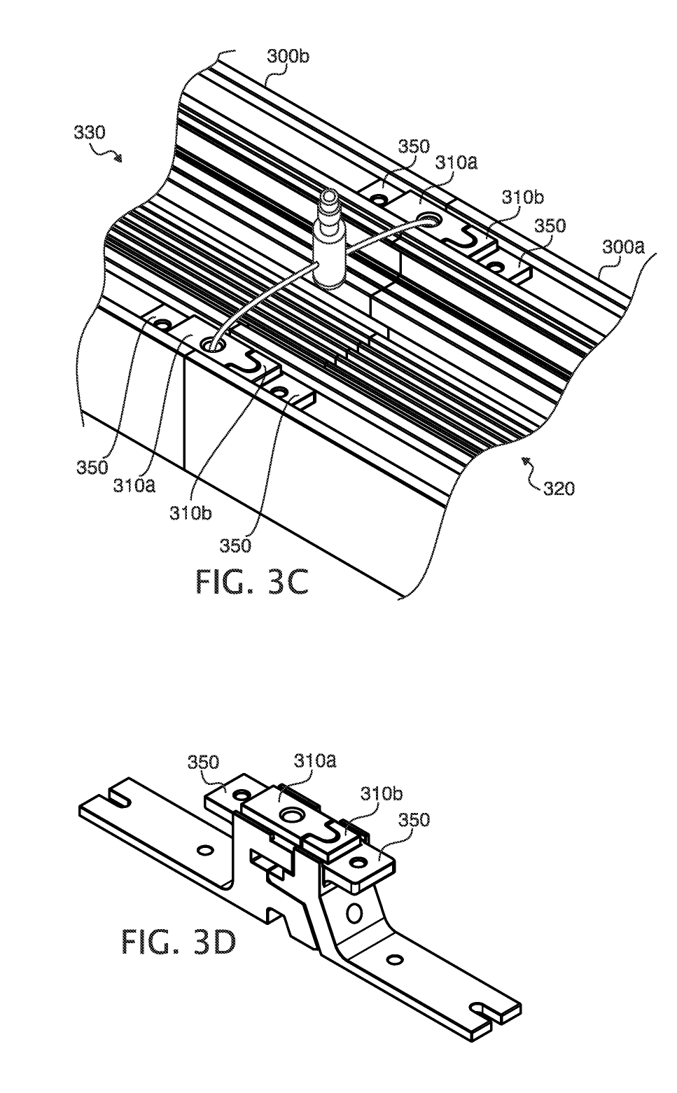

FIG. 3A is a perspective view of a heat sink 112 that may comprise all or a portion of the heat sink for the light sources of FIG. 1 and FIGS. 2A-2C in accordance with the subject technology. Heat sink 112 is made of conductive material such as an aluminum alloy or any other material sufficient to dissipate heat generated by the driver circuit and lamps of the light sources. Heat sink 112 has a consistent cross-section throughout its length and may be made by an extrusion process to be any length (presently 1 foot and/or 2 feet are believed to be preferred). While heat sink 112 has been illustrated as having a substantially rectangular shape (formed by three walls), it is contemplated that heat sink 112 could be semi-circular (potentially formed by one wall), triangular (potentially formed by two walls), or any other desired shape. It is only significant that heat sink 112 dissipate heat and have one or more walls that create a central cavity 340. As illustrated, heat sink 112 includes a variety of grooves and protrusions many of which are intended to increase the speed and efficiency at which heat is dissipated by the structure. The grooves and protrusions may also facilitate the securing of interior or exterior components to the heat sink 112. Thus, the heat sink 112 is also a housing for interior components. As shown in FIG. 3A, the protrusions 350 may provide a flange with which to secure an optical structure such as the first optical structure 240 depicted in the previous figures. Protrusions 320 may provide a flange onto which a printed circuit board containing a driver circuit may be secured. Protrusions 330 may function purely to aid in the dissipation of heat but may additionally be used to secure an electrical component such as a ribbon cable. Exterior protrusions 360 may be used to secure heat sink 112 to a light fixture, such as the light fixtures of FIGS. 2A-2C. A plurality of holes (not shown) may be disposed in any location of the heat sink to facilitate fastening of any exterior or interior component to heat sink 300.

FIG. 3B is a perspective view of two heat sinks 300a and 300b that have been joined together to form heat sink 300 in accordance with the subject technology. Heat sinks 300a and 300b are joined by connectors 310a and 310b. Connectors may be disposed in a groove 320 of heat sink 300. Heat sinks 300a and 300b may alternatively be joined by connections that are integrally formed in the body of heat sinks 310a and 310b. FIG. 3B also illustrates that affixable end caps 315a and 315b may be added to the free ends of the heat sinks within the subject system to provide enclosure for the fixtures.

FIG. 3C-3F are detailed, perspective views of one potential embodiment of connectors 310a and 310b that may be used to join the heat sinks 300a and 300b of FIG. 3B in accordance with the subject technology. Connectors 310a and 310b are oriented such that two male connectors are used at the end of heat sink 300a and two female connectors are used on the end of heat sink 300b abutting 310a. The connectors may be individually secured to its respective heat sink with fasteners 340. The connectors may be discrete pieces as shown in FIG. 3D, to reduce the number of connectors that are required and to allow the heat sink to be formed via extrusion. Ends of heat sinks 300 that do not abut another heat sink need not have any connector affixed. Each male connector may be joined with its respective female counterpart with a fastener in holes 350. Holes may be provided at an angle, such as a forty-five degree angle to provide a secure, removable connection between the connector 310 and the heat sink 300. Heat sink 300 and connectors 310 may be further secured together by screws 320 and a cable 330 to promote the strength of the connection. Cable 330 may additionally be used to further secure heat sink 100a to 300b. Cable 330 may be connected to portions of the light fixture.

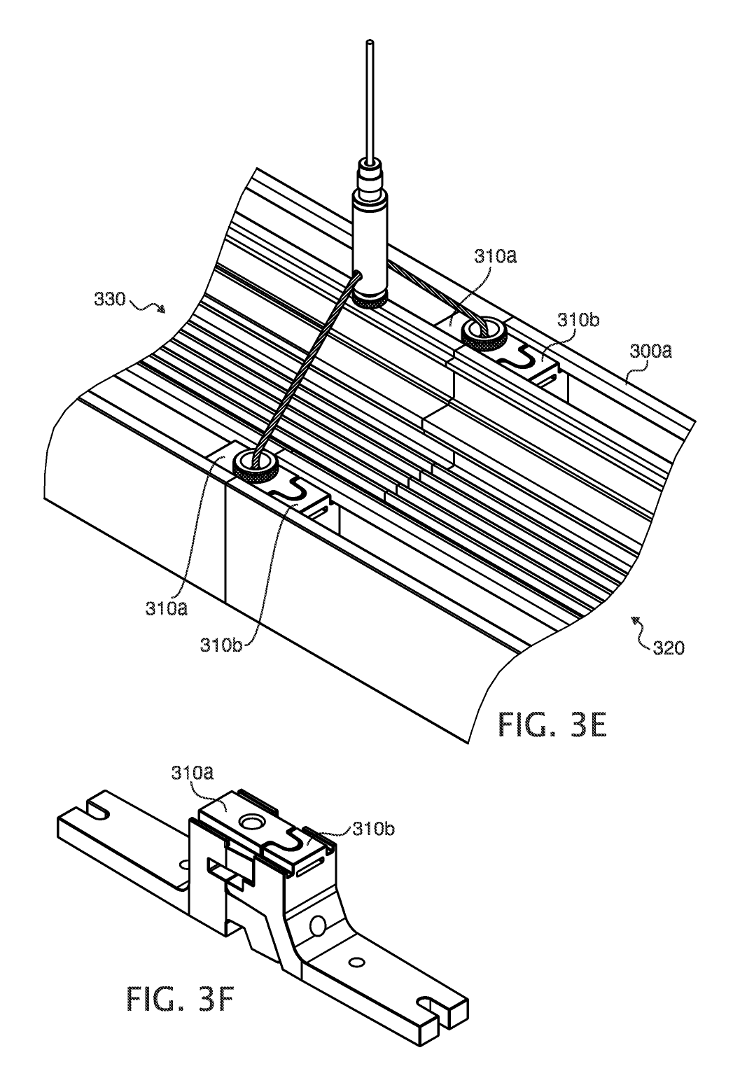

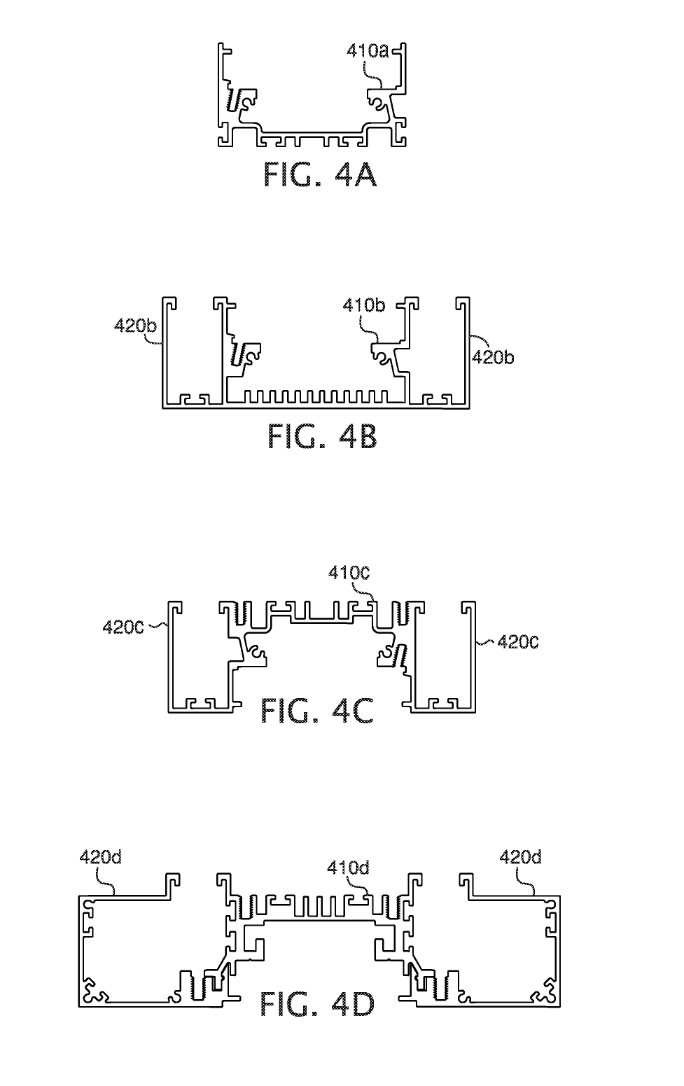

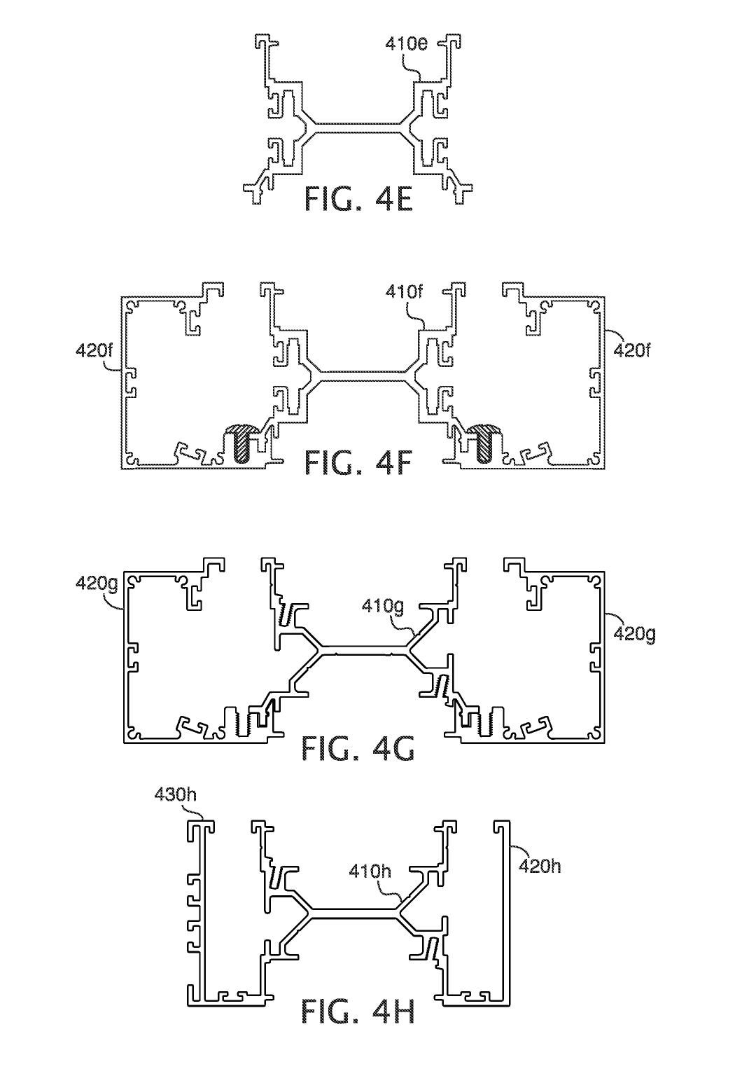

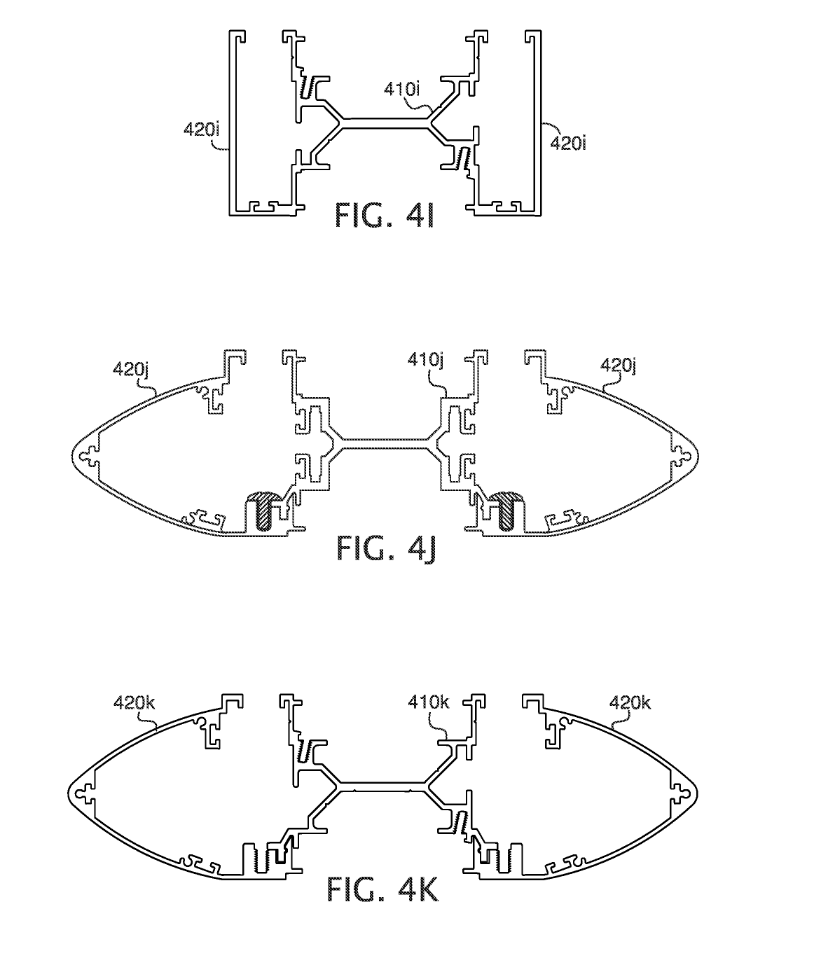

FIG. 4A-4D are cross-sectional views of additional embodiments of a heat sink for use in light sources in accordance with the subject technology. The heat sinks 410a, 410b, 410c, and 410d, like the heat sinks of previous figures, function as a heat sink for a light source and additionally functions to secure interior or exterior components of a light source. The heat sinks of FIGS. 4A-4D may additionally be joined together with connectors to provide multiple lengths of heat sink to form a single light source. Heat sinks 410a-410d may be constructed in a similar manner, containing grooves and protrusions (some not shown) for the purpose of facilitating heat dissipation and for the purpose of securing exterior and interior elements.

FIG. 4E-4K are cross-sectional views of additional embodiments of dual sided heat sink for use in light sources in accordance with the subject technology. The heat sinks 410e, 410f, and 410g, 410h, 410i, and 410k, like the heat sinks of previous figures, function as a heat sink for a light source and additionally function to secure interior or exterior components of a light source. The heat sinks of FIGS. 4E-4K may additionally be joined together with connectors to provide multiple lengths of heat sink to form a single light source. Heat sinks 410e-410k may be constructed in a similar manner, containing grooves and protrusions (some not shown) for the purpose of facilitating heat dissipation and for the purpose of securing exterior and interior elements. Heat sinks 410e-410k are sized and shaped such that drivers, lamps, and optical structures built for use with single sided heat sinks (such as those of FIGS. 3A-3C and 4A-4D) may be interchangeably used on either side of the dual sided heat sinks 410e-410k.

Unlike the heat sinks shown in previous figures, the heat sinks 410e, 410f and 410g, 410h, 410i, 410j, and 410k are configured with dual central cavities to accommodate drivers, lamps, and optical structures on two sides. Each cavity is shaped identically such that the drivers lamps and optics of the subject technology may be modularly installed on each side. Each of the dual central cavities may be independently wired so as to provide independent lighting on either side. For example, one of the dual cavities may be installed with lighting that is designed to be used with a generator during power outages. In another example, opposing sides of the heat sinks 410e-410k may be separately wired such that an uplight may be controlled separately from a downlight, including separate dimming capabilities. The dual cavity heat sinks reduce the space required to use two separate heat sinks by sharing a common side of the heat sink. Accordingly, light fixtures built to accommodate only single sided heat sinks are not interchangeable with dual sided heat sinks due to the increased height of the dual sided heat sinks. However, light fixtures built to accommodate dual sided heat sinks may be adapted for use with single sided heat sinks. The heat sinks 410b, 410c, 41d, 410f, 410g, 410h, 410i, 410j, and 410k may include additional respective side portion(s) 420b, 420c, 420d, 420f, 420g, 420h, 420i, 420j, and 420k to facilitate the use of one or more different fixtures of different shapes, particularly for use with pendant mounted light sources. Any of the heat sinks 410 may additionally or alternatively include a side mount section 430h to facilitate use with wall mounted light sources. Heat sinks may be additionally shaped such that a left portion 420 differs in shape from a respective right portion of 420.

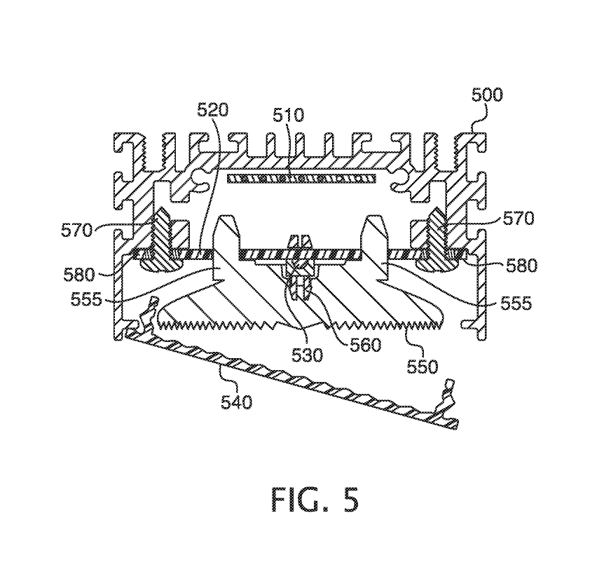

FIG. 5 is a cross-sectional view of any one of the heat sinks of the prior figures in accordance with the subject technology. The components within heat sink 500 may also be disposed in an identical configuration within the cavity of either side of the dual heat sinks of FIGS. 4A-4C. Components disposed within heat sink 500 include first and second optical structures 540 and 550, a PCB 520, a ribbon cable 510, lamp 530, pin fastener 560, and fasteners 570. Multiple components may be disposed within heat sink 500 in a linear fashion.

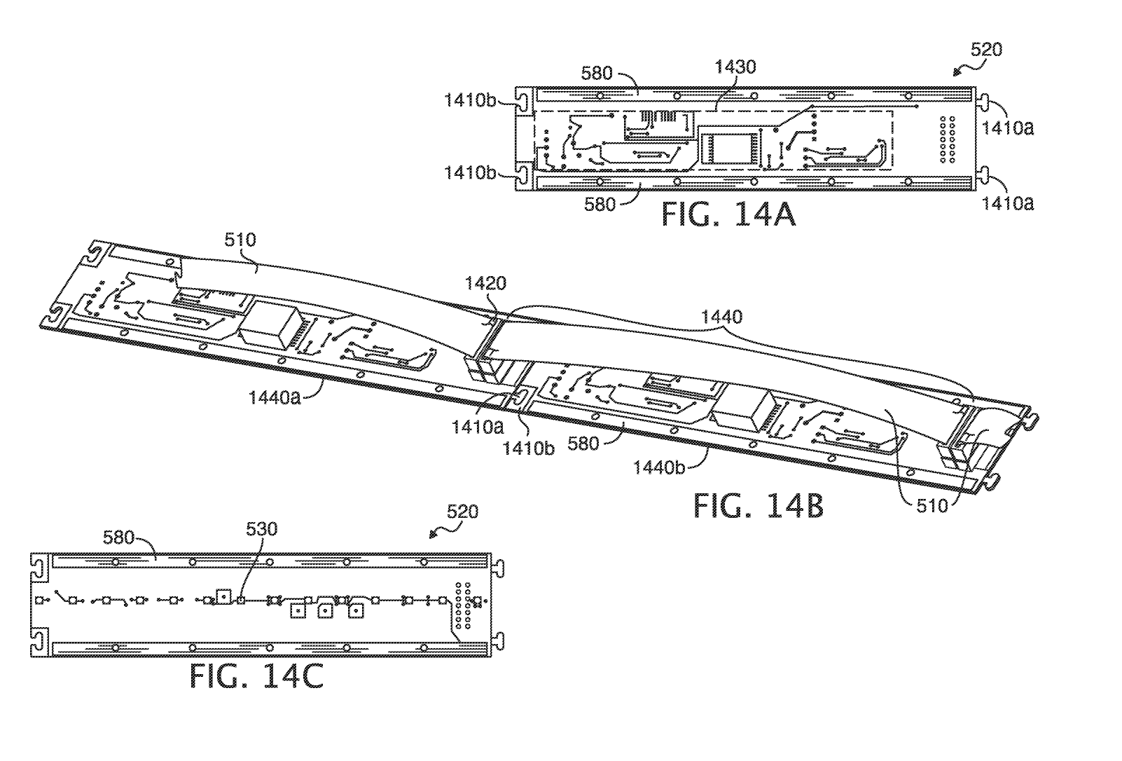

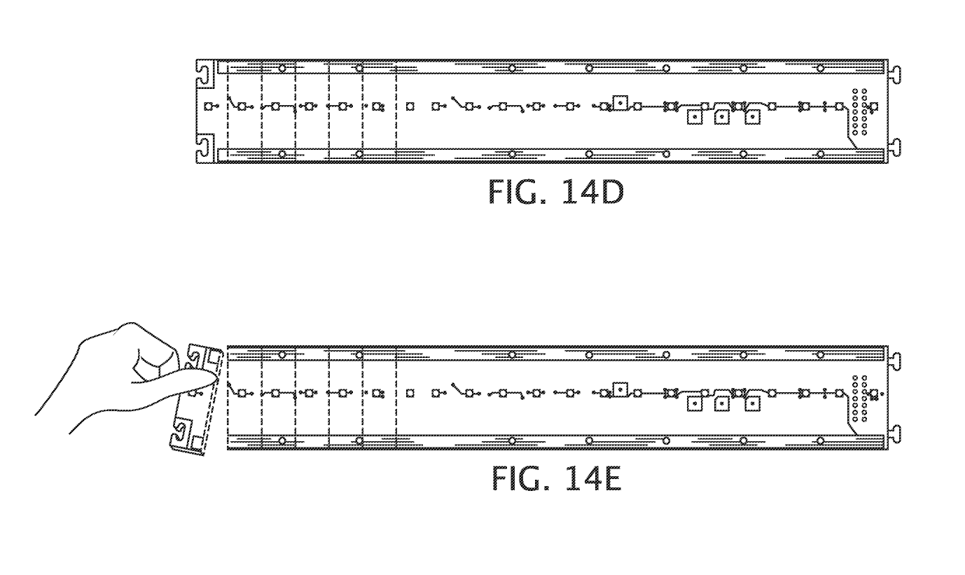

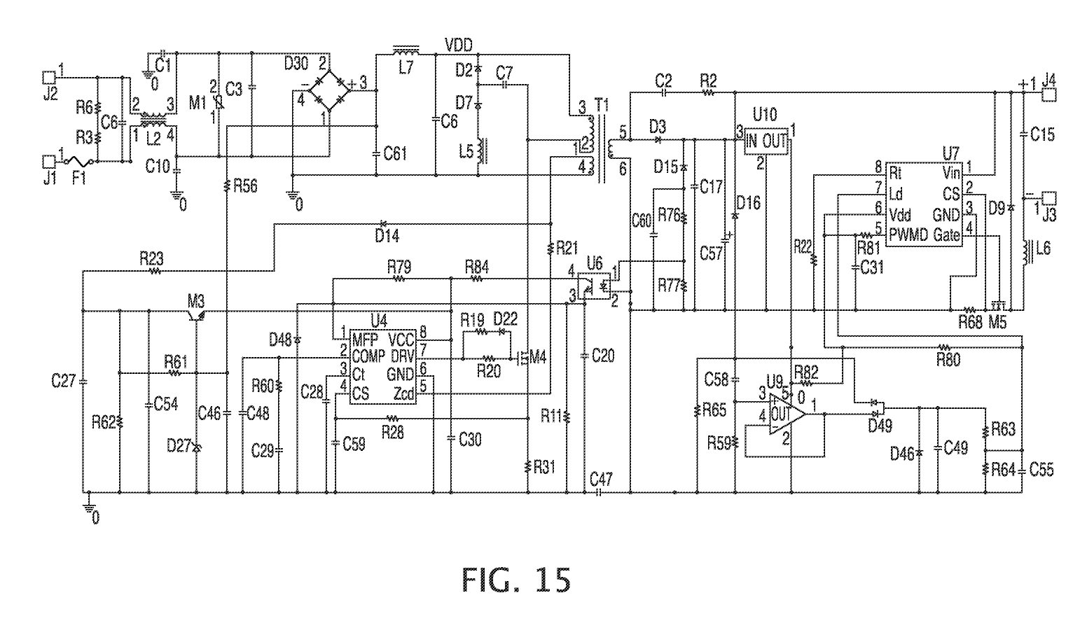

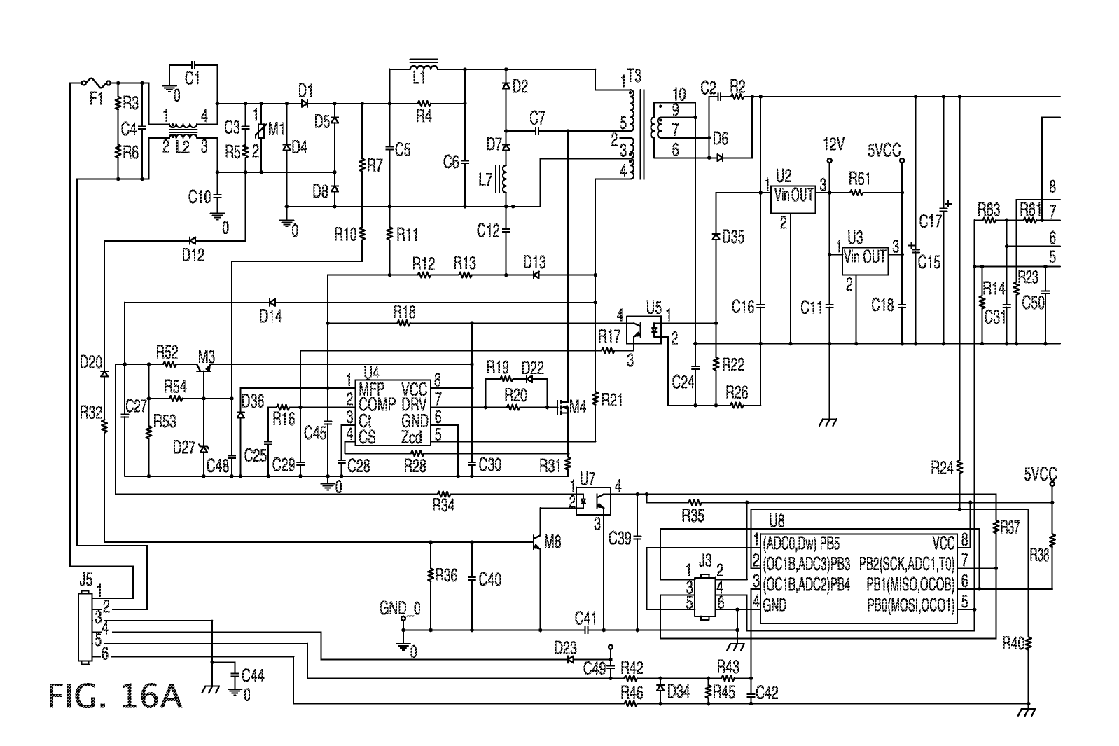

As illustrated in FIGS. 14A-14E, PCB 520 may further comprise at least one heat conducting strip 580 that is disposed within PCB 520 with a thickness that is substantially equal to the thickness of the PCB 520. The heat conducting strip 580 may be disposed along the length of the PCB 520 near one edge. The PCB 520 may further preferably comprise a similar (if not identical), second heat conducting strip 580 that is disposed within the PCB 520 near the opposing edge. The components of the driver circuit (being very roughly illustrated in FIGS. 14A and 14B) are disposed substantially between the two heat conducting strips 580 on one side of the PCB 520 and the lamps 530 (roughly illustrated in FIG. 14C) are disposed substantially between the two heat conducting strips within the opposing side of the PCB 520. The heat conducting strips 580 may be composed of any conductive material including, but not limited to, copper, or any other type of metal that conducts heat. Holes may preferably be disposed within the PCB 520 such that they are substantially contained within the heat conducting strips 580. Such holes would be used to removably fasten the PCB to the heat sink 112 using mechanical fasteners 570 made of a heat conductive material. Heat conducting strips 580, fasteners 570, and their mechanical connection with the heat sink 112 provide for efficient heat conduction from the PCB 520 and components disposed therein. This furthers a goal of the invention to effectively dissipate heat generated during the operation of the light source.

Lamps 530 disposed on PCB 520 are preferably semi-spherical solid state lamps. For example, the lamps may be light emitting diodes (LEDs), such as Cree® XLamp® XB-D White LED and Cree® XLamp® XM-L LED lamps. It will be understood that other solid state lamps (preferably semi-spherical) may be used with the subject technology without departing from the intended scope of the present invention.

The PCB 520 further contains holes such that a first optical structure 550 may be mounted in operable physical registration with one or more lamps 530 disposed in PCB 520. First optical structure 550 may be secured in operable physical registration with the PCB using one or more pin fasteners 560. As illustrated, pin fastener 560 may be constructed of nylon, acrylic or any other suitable material. Any other type of fastener may be used so long as operable physical registration can be maintained between first optical structure 550 and the lamps 530 mounted on PCB 520 via mechanical engagement between the first optical structure 550 and the PCB 520. The first optical structure 550 may be operably aligned with the lamps 530 of PCB 520 using pins 555. Pins 555 are preferably formed integrally with first optical structure 550 and, thus, will be made of the same material as the first optical structure 550.

The driver circuit will be disposed on the one side of the PCB 520 intended to be installed facing the inner side of the top wall of the heat sink 112 leaving the plurality of lamps substantially surface-mounted on the opposite side of the PCB opposing the driver circuit. The lamps would be disposed in the PCB face such that they align with one of the openings in first optical structure 550. As illustrated in FIG. 14C, the lamps 530 are preferably disposed along a substantially straight line proximate the middle of the PCB face. Each of the plurality of lamps disposed on the PCB are operably connected to the driver circuit on the opposite face of the PCB. In turn, the driver circuit may be electrically connected to additional driver circuits on other PCBs to form a single light source. Electrical connections between PCBs (and from a PCB to AC mains power) are preferably provided by ribbon cable 510. As illustrated in FIG. 2A-2C, the ribbon cable 510 may be disposed in the central cavity of heat sink 112 or may alternatively rest on protrusions of the heat sink 112 such that space is maintained between the driver circuit of the PCBs and the ribbon cable throughout the length of the light source. The PCB may further contain connectors (not shown) that may be electrically connected to an exterior alternating current (AC) power source.

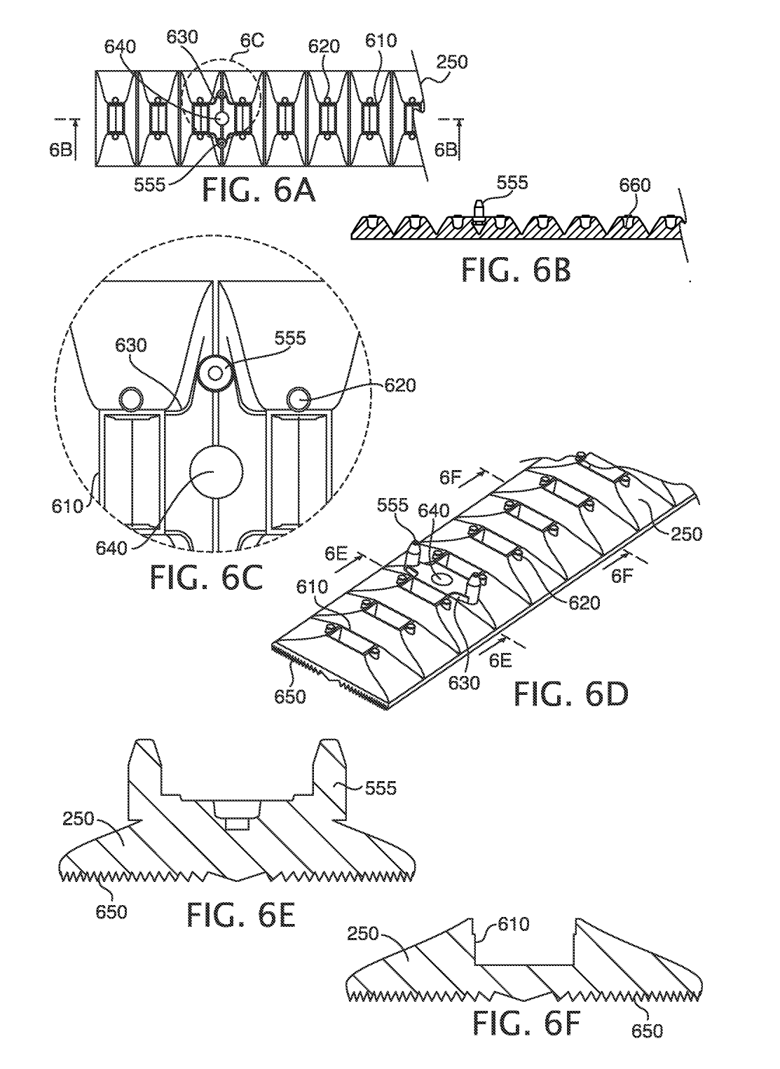

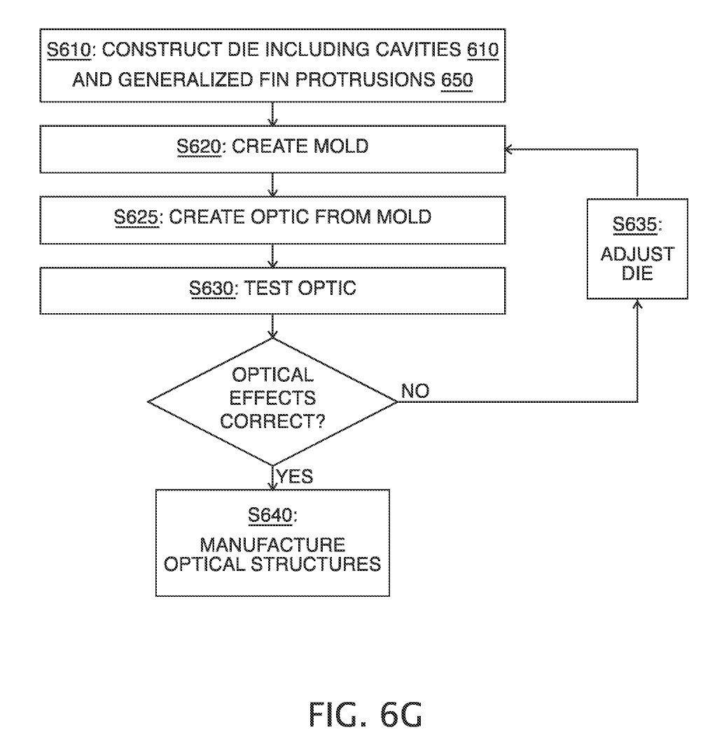

FIG. 6A is a bottom view of at least a portion of the first optical structure 250 for a light source in accordance with the subject technology. FIG. 6B is a cross-sectional illustration of the same portion of the optical structure illustrated in FIG. 6A. FIG. 6C is a detailed view of the optical structure of a portion of FIG. 6A as indicated in FIG. 6A. FIG. 6D is a perspective illustration of the portion of the optical structure of FIG. 6A. FIG. 6E is a cross-sectional view of the optical structure of FIG. 6A as indicated in FIG. 6D.

So, as collectively illustrated by FIGS. 6A-6E, the first optical structure 250 is a lens that is constructed for use in the linear light sources of FIG. 1, among other potential light sources. The first optical structure 250 collects the light emitted from multiple lamps and redirects that collected light to provide a consistent and uniform non-focused light. The length of the first optical structure 250 may be made in a variety of lengths including, but not limited to, one foot, two feet, or any other lengths to accommodate light sources with varying lengths and varying numbers of lamps. Two or more first optical structures 250 may be used end to end to form a longer optical structure. Light emitted from multiple lamps is redirected by the optical structure 250 to reduce color separation and image separation in the emitted light.

The use of internal reflection and the calibration of the optical effects in the first optical structure 250 preferably provide greater efficiency than can be achieved by structures previously known in the art. As illustrated in FIGS. 6A-6F, the first optical structure 250 includes cavities 610 with substantially rectangular openings terminating in “U” shaped surface 660 (see FIG. 6B), fin-like protrusions 650, registration protrusions 620, connector portion 630, pins 555, and cavity 640. Pins 555 are aligning pins that interact with holes on PCB 520 to keep the first optical structure 250 in operable registration with the lamps. An additional pin (such as pin 560 illustrated in FIG. 5) may engage cavity 640 on the first optical structure 250 as well as a hole on PCB 520 to substantially secure the optical structure 250 to the PCB. The pins 555 and registration protrusions 620 also function to maintain the operable registration between optical structure 250 and the lamps. Registration protrusions 620 are disposed adjacent to each of the shorter sides of each rectangular opening of cavities 610 and operate as stand-offs to ensure that a fixed minimum distance is maintained between the optical structure and the lamps. Registration pins 620 further aid in the release of the first optical structure 250 from the injection mold during the formation process for the optical structure.

First optical structure 250 includes two optical elements. The term “optical element” as used herein encompasses its plain and ordinary meaning, including, but not limited to one or more surfaces of an optical structure that are shaped and sized to produce an optical effect when light is transmitted through the optical structure. Multiple optical elements may be configured on a single optical structure such that multiple lamps may be used together in a single optical structure to produce the desired effect. The first optical element acts as a total internal reflection (TIR) optical element. This optical element significantly collimates light emitted from the lamp associated with that element (i.e. there is a single lamp to single TIR relationship). This optical element furthers a preferred goal of the invention by efficiently collimating a significant portion of the light emitted by the solid-state lamps. The TIR optical element includes cavities 610, each with a rectangular opening extending into optical structure 250. The termination surface 660 of each cavity 610 has a concave surface, that is the interior termination of each cavity 610 is a “U” shaped trough. Cavities 610 and termination surfaces 660 are sized and shaped such that the emitted light is collimated to create even illumination down the length of the optical element at a fixed width.

Fin protrusions 650 function as a second optical element and are disposed on the opposing side of the first optical structure 250 furthest from the lamps. Fin protrusions 650 run substantially the length of the optical structure with substantially uniform cross-sections throughout the length of optical structure 250. FIGS. 6D-6F are merely intended to illustrate the fin protrusions 650 and thus are not drawn to provide an exact layout of these elements. Rather, the shape, size and relative placement of each fin protrusion 650 is generally determined by equations that determine a final resulting spread angle and uniformly consistent light. A preferred spread angle may be twenty-four degrees. The shape and size of each fin protrusion 650 is then finalized by considering the type of material, injection mold process, and/or temperature, among other details of fabrication. Fin protrusions 650 collectively act to provide evenly spread light with a spread angle corresponding to a width of a second optical structure at a fixed distance from optical structure 250. The length of the focal point is determined such that the focal point is a distance beyond the maximum distance at which the emitted light is visible to the naked human eye.

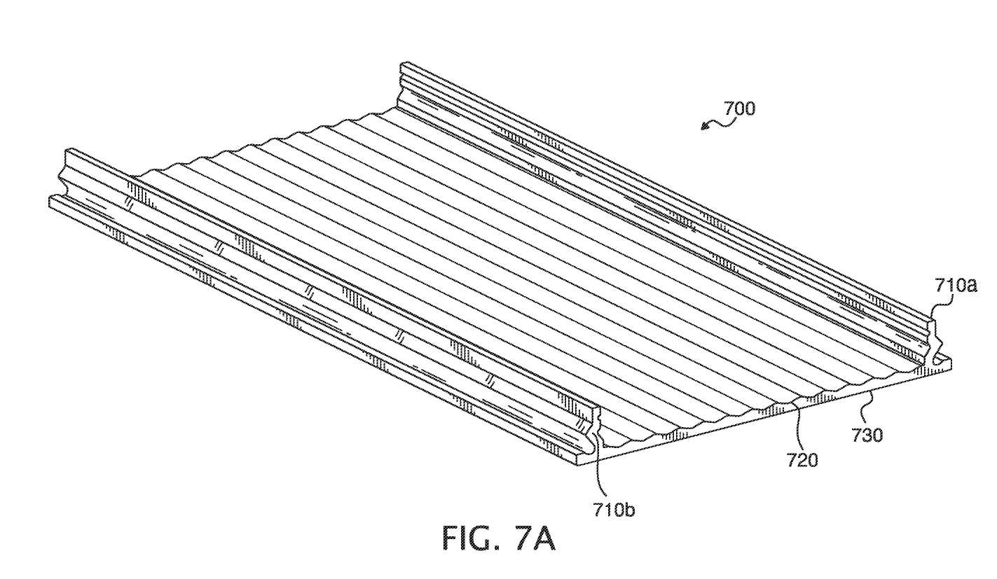

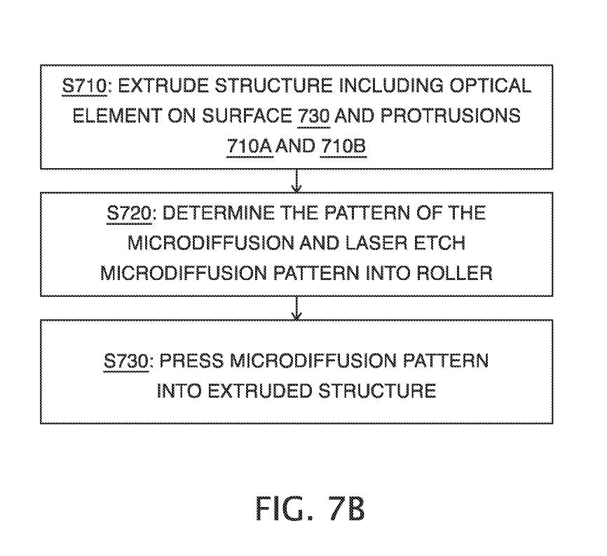

FIG. 6G is a flow chart illustrating a method for making the optical structure of FIGS. 6A-6E. Optical structure 250 is formed in an injection mold process using acrylic resin such as Plexiglas® V825 manufactured by Altuglas International, or the like. This process includes creating a die from hardened steel, aluminum, beryllium-copper alloy or other suitable, material. In S610, a die is constructed with the structure for the cavities 610, connector portion 630, pins 555, and registration protrusions 620, and the initial, general shape of fin protrusions 650. A mold is created in S620, an optic is created in the injection mold for testing in S625, and in S630, a test optic is created. The optical effects of the fin protrusions are tested for expected optical performance. Among other tests, a laser may be used to determine the output characteristics of the light. A final mold is created in S640 for manufacture of optical structures. If the test optic does not achieve the desired optical effects, the die is adjusted or remade and steps 620, S630, and S635 are repeated until the test optics achieves the desired result. Once optical structure has been poured and formed through the injection molding process, registration protrusions 620 aid the mold maker in freeing optical structure 250 from the mold. The completed optical structure 250 may be used in conjunction with one or more optical structures of FIG. 7A.

FIG. 7A is a perspective view of a second optical structure 700 in accordance with the subject technology. The second optical structure 700 may be used in various light sources of the previous figures. Optical structure 700 may be made in a variety of widths for use, for example, optical structure 700 of FIG. 7A may be used in two widths as both the optical structure 220 and the first optical structure 240 of FIG. 2A. Second optical structure 700 may be made of any available flexible optical plastic. Second optical structure 700 is preferably formed into a piece as illustrated in FIG. 7A through an extrusion process. An optical element may be disposed on surface 720 to provide light spreading or other optical effect. The term “spread” as used herein encompasses its plain and ordinary meaning, including, but not limited to, an optical effect is created such that light is directed to a fixed width or length expressed in degree. Protrusions 710a and 710b may be used to snap the optical structure into the heat sink portion of the light source. For example, the second optical structure 700 may be used with heat sink 112. As illustrated in FIGS. 2A-C, the protrusions 710a and 710b (see FIG. 7A) are preferably positively engaged by protrusions of the heat sink 112 (see protrusions 350 in FIG. 3A). Although second optical structure 700 may be easily removed from the heat sink, the protrusions 710a and 710b are shaped such that the second optical structure is not likely to disengage from the heat sink during operation of the light source. The second optical structure may be disposed in a light fixture of a light source so that the second optical structure works in tandem with the first optical structure attached to the plurality of lamps. The distance between the two optical structures may be of a fixed distance.

Optical structure 700 may be made through an extrusion process. Optical effect on surface 720 may preferably be formed as part of the extrusion process in which optical structure 700 is created. FIG. 7B is a flow chart illustrating a method for making the second optical structure 700 of the type illustrated in FIGS. 5 and 7A. In S710, optical structure is created through an extrusion process that creates the body of structure 700 including optical element on surface 720 and protrusions 710a and 710b. In S720, the pattern of the microdiffusion is determined using equations including fractal geometry equations and implemented into the roller via a laser etch process. An optical element on surface 730 creating a microdiffusion effect may be created by using a roller press to impress the microdiffusion pattern into the optical structure following extrusion in S730. The roller press step occurs following the extrusion process and before the extruded optical structure cools to room temperature.

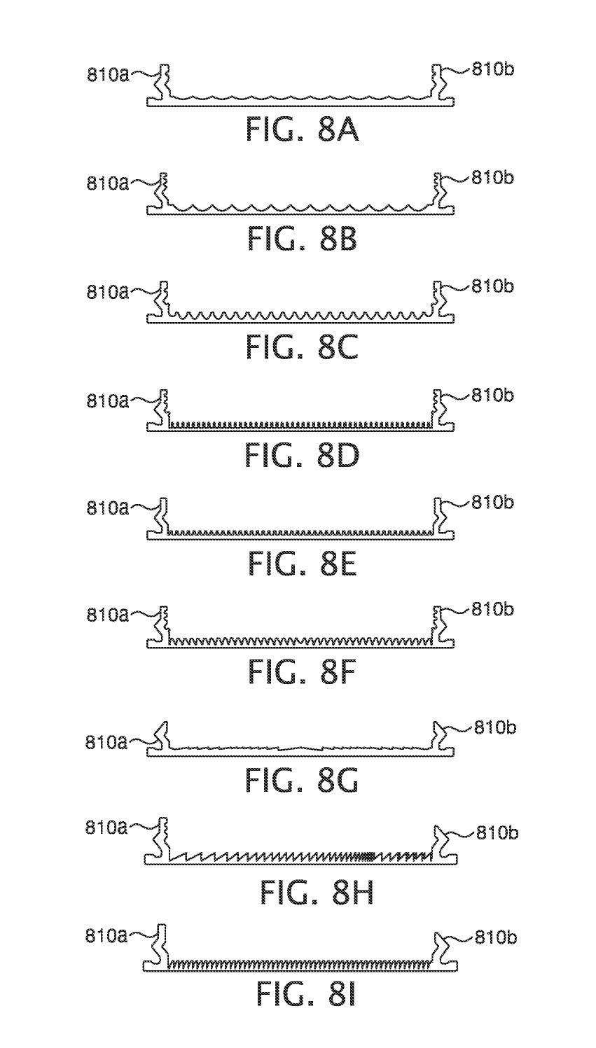

FIGS. 8A-8I are end views of the second optical structure 700 of FIG. 7A. FIGS. 8A-8I represent some of the various combinations of optical elements that may be created on surfaces 720 and 730. (The illustrations of FIGS. 8A-8I are not drawn to reflect the exact appearance of such optical elements, but rather are illustrated in such a way as to illustrate some of the wide variety of elements that may be used on the optical structures of FIGS. 8A-8I.) By way of example (and not limitation), such optical elements may include spreads of ten degrees, thirty degrees, forty-five degrees, sixty degrees, one hundred twenty degrees, and the like. Optical effects may be designed such that the optical structure 700 may be used for grazer light sources, cove light sources, wall washes, and the like. Optical structures of FIGS. 8A-8G are created such that they are symmetric with respect to an axis running the length of the optical structure. For example, an optical effect such as a thirty degree spread can be created such that light leaving the optical structure is spread fifteen degrees on either side of the axis running the length of the optical structure.

As the type of optical effect provided by the second optical structure will not be visible to the naked eye during installation (and before operation), the protrusions 810a and 810b are preferably shaped to communicate to an installer the optical effect provided by a particular structure based on a shape of the protrusions. One particular scheme for providing these visual cues to the installers is illustrated in FIGS. 8A-8I. In the illustrated scheme, the protrusions may be symmetrical or asymmetrical and have a varying number of notches 811 to communicate the degree of spread provided by the optical element. In the second optical elements with symmetrical protrusions (i.e. FIGS. 8A-8G), communicates that these overall optical elements each produce an optical effect that is symmetric around the axis running the length of the optical structure. Asymmetrical protrusions (i.e. FIGS. 8H and 8I) would preferably communicate that the optical effects provided by the optical element is directional, i.e., the optical effect is not symmetric with respect to the axis running the length of the optical structure. The direction of the optical effect is indicated by shaping the protrusion 810a or 810b in the direction of the optical effect and using a clean detail or a shape indicating no optical effect on the side of the optical structure that is furthest from the direction of the optical effect.

As would be understood by those of ordinary skill in the art having the present specification and drawings before them, the protrusions 810a and 810b need not be shaped as illustrated in the FIGS. 8A-8I; rather, any shape may be used to designate any optical effect, so long as the shape is uniformly and consistently used to identify an optical effect. Shaping of the protrusions in this manner furthers a goal of the invention of making the optical effect of the optical structure more easily identifiable for installation or changing of the optical structure 700. Similarly, while FIGS. 8H and 8I have been illustrated to make the asymmetry of the optical effect discernible, in practice it is unlikely that the direction of the optical effect would be easily identifiable to the naked eye prior to operation. Thus, shaping of the protrusions to indicate the direction and type of optical effect furthers a goal of the invention by creating an easily identifiable type and direction of optical effect that allows for ease of installation, replacement, or change. Additionally, two directional optical effects may be created in an optical structure 700. In illustrated case, each protrusion is shaped to reflect the optical effect in the direction nearest each respective protrusion.

Several optical structures may be used in a single light source, or several light sources may be grouped together. The length of the optical structure may be made in a series of parts to facilitate customization of light effects for a room. The width of the optical structure may be uniform, regardless of optical effect, to facilitate the interchangeability of the optical structures and to maximize the ability to customize light sources for a particular environment. Optical effects may also be varied to create an aesthetically pleasing effect or to follow the structure of the room, such as accommodation of windows, doorways, or other structural elements of a room. Thus, the installation of light sources for a room may use a variety of optical structures in a single room. Identifiable protrusions on the optical element thus reduce the time required to install, change, or replace optical elements by providing an easily identifiable optical effect and additionally reduces the occurrence.

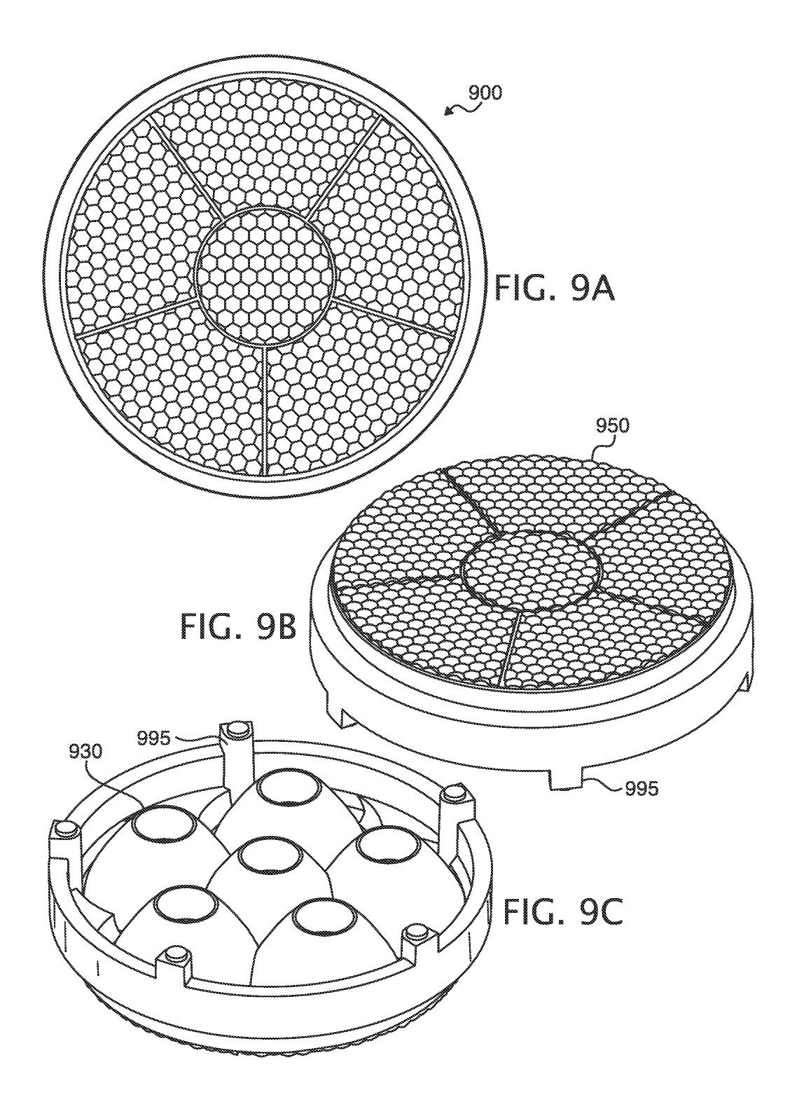

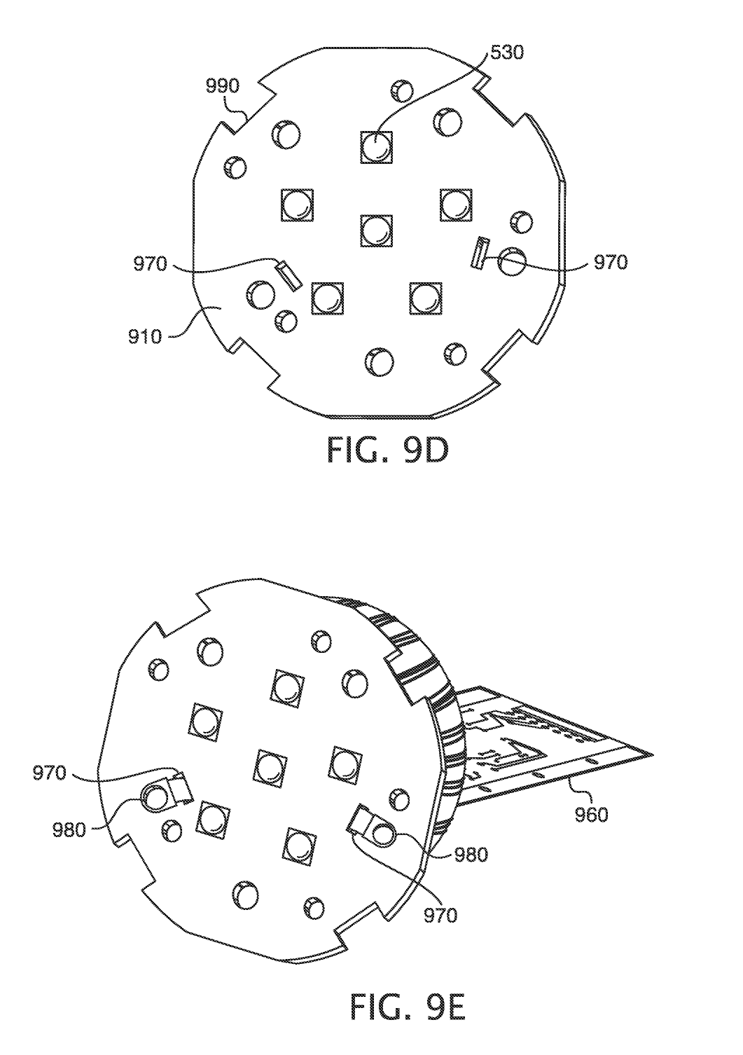

FIGS. 9A-11C illustrate various perspectives of optical structures that may be used with the types of light sources such as pendant light 160 and recessed can light 170 of FIG. 1. The optical structures of FIGS. 9A-11C may be scaled for light sources containing two, or more lamps and may be contained in housings that include Edison-type bases. Optical structures for six lamps, three lamps, and four lamps are illustrated in FIGS. 9A-C, 10A-D, and 11A-C, respectively. The optical structure may be formed of the same materials as optical structure 250.

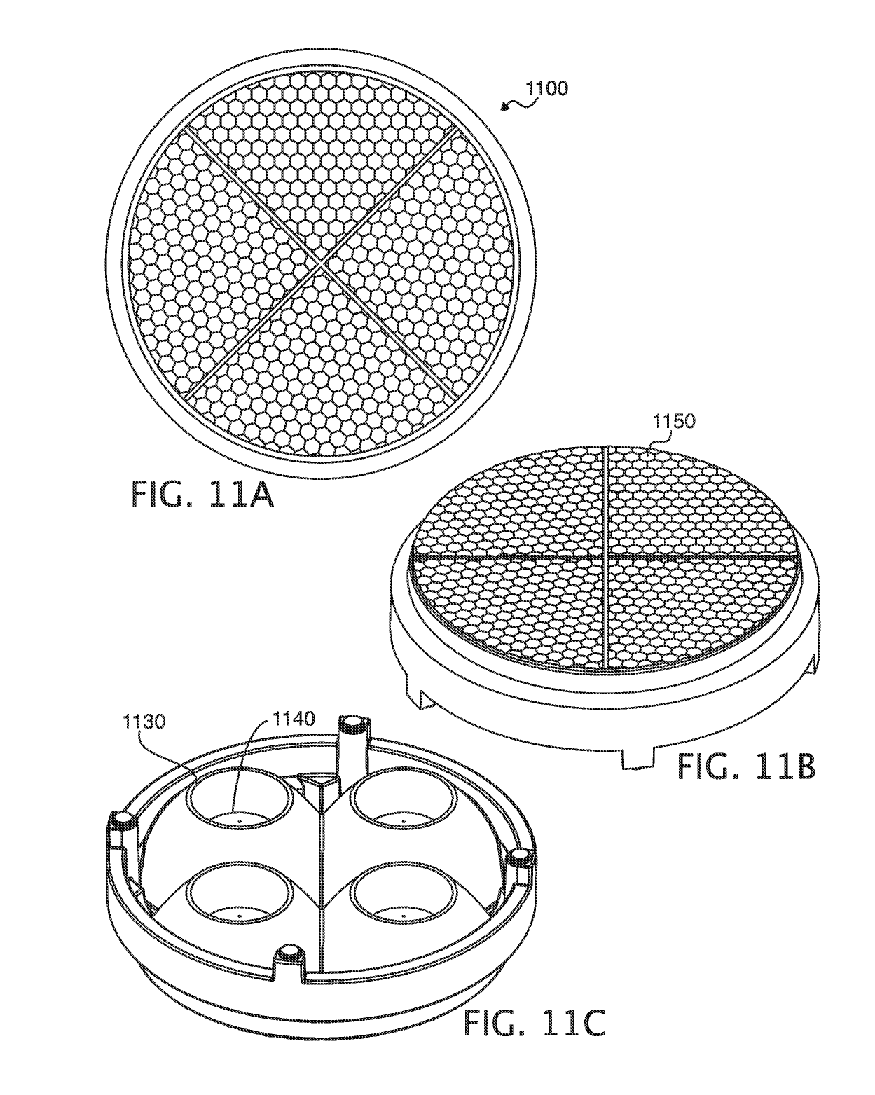

Each of the optical structures 900, 1000, and 1100 of FIGS. 9A-11C include three optical elements. The first optical element acts as a total internal reflection (TIR) optical element that substantially collimates light emitted from each of the lamps. The first optical element furthers a goal of the invention by collimating the emitted light efficiently. For each lamp, a column shaped cavity 930, 1030, and 1130 is formed in the surface of the optical structure 900, 1000, and 1100 nearest the lamp and extending into the optical structure. The column shaped cavity has a substantially uniform radius throughout the length of the cavity. The termination of each cavity is shaped as a convex surface, and the apex of the convex surface (visible from the perspective illustrated in FIG. 11C as surface 1140) is substantially aligned with the apex of each respective lamp. The light emitted from each first optical element may be of a substantially identical, fixed diameter. The length of the column shaped cavity is determined in accordance with the desired optical effects.

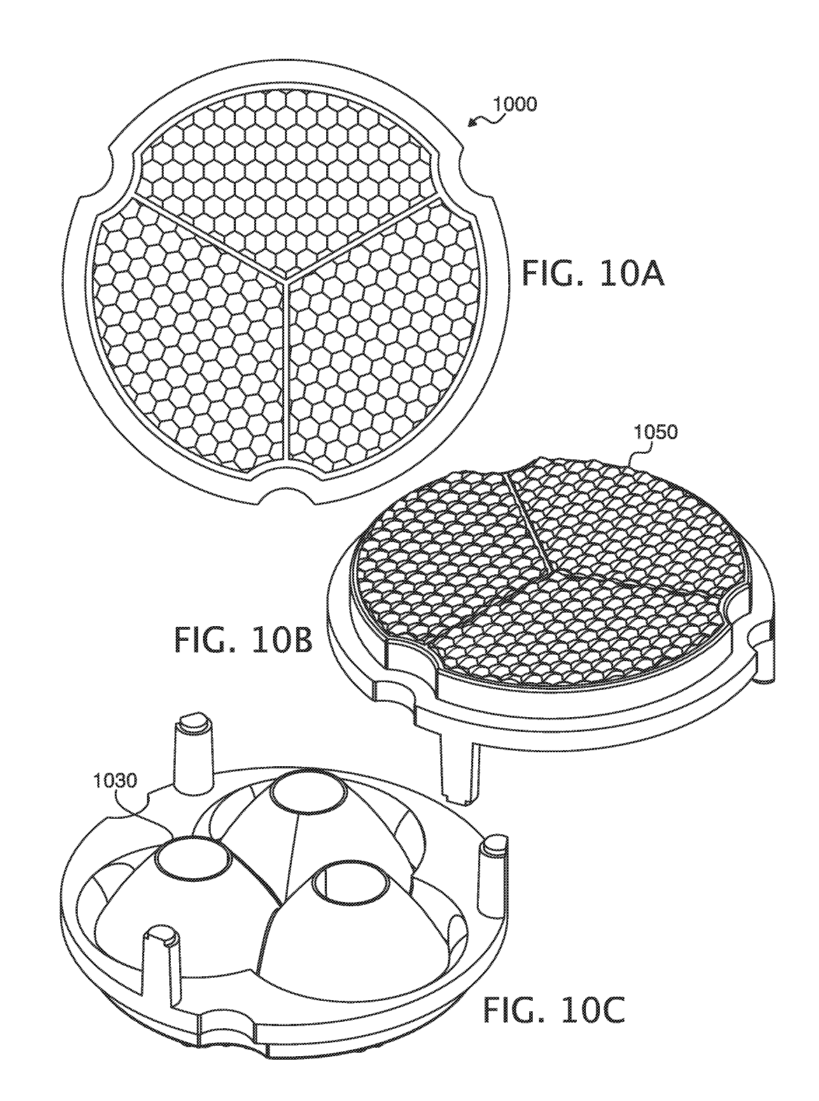

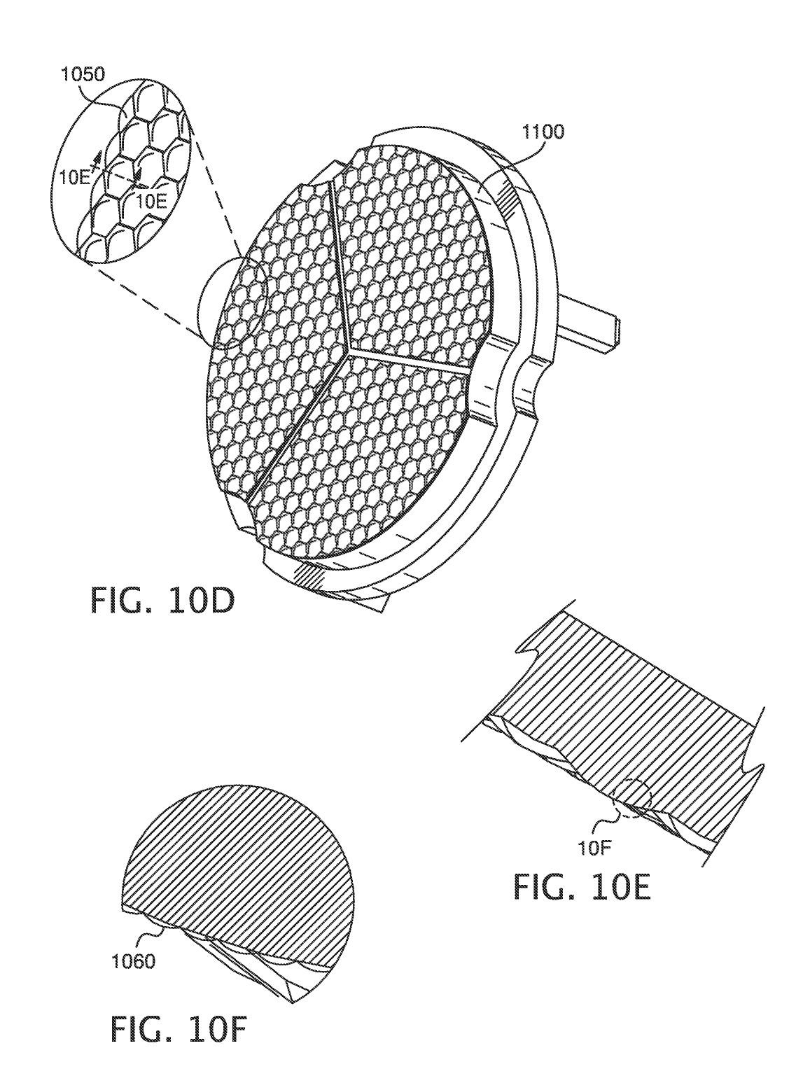

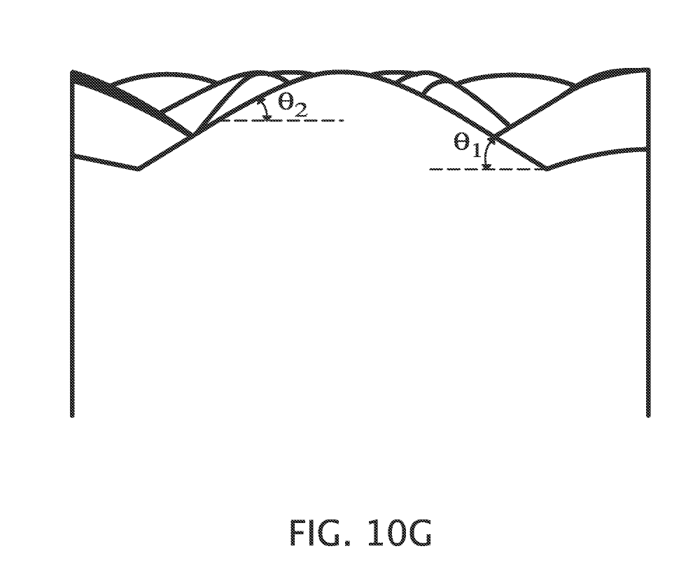

A second optical element of the optical structure is comprised of protrusions 950, 1050, and 1150 on the side of the optical structure opposite the first optical element. Multiple protrusions 950, 1050, and 1150 form the second optical element for each of the lamps of each light source. Each second optical element receives the collimated light from the first optical element and emits multiple optical images with substantially infinite focal points. Each optical image emitted by the second optical element corresponds to each of the protrusions 950, 1050, and 1150. Multiple protrusions 950, 1050, and 1150 make up each second optical element. Each protrusion 950, 1050, and 1150 has two stages. The first stage of each protrusion 950, 1050, and 1150 extends from a hexagonal base on the surface of the optical structures 900, 1000, and 1100 outward and away from the respective lamps. As illustrated in FIG. 10G, each side of the six sides forms an acute angle, Θ₁, with respect to the surface of the optical structures 900, 1000, and 1100 extending so that each of the sides begin to converge towards a central apex. Angle Θ₁ may be based on the desired spread angle of the light source and the index of refraction of the material of the optical structure. Angle Θ₁ may also be adjusted to work in tandem with other optical effects to produce the overall desired optical effect. The second stage of each protrusion 950, 1050, and 1150 also has a substantially hexagonal base that is formed by the top six sides of the first stage. As further illustrated in FIG. 10G, the six sides of the second stage extend at an angle, Θ₂, that is more acute than the corresponding first side from which it extends, resulting in a slope of the second stage that is less than the slope of the first stage. Angle Θ₂ is chosen to create an even spread of illumination. Each of the sides of the second stage converge at their top sides. Each side of the first and second stages constitutes a facet. Each transition between facets is rounded such that no sharp edge exists between any to facets on any aside. Each side of the first and second stages has a convex surface, i.e., each side of each stage is a spherical cap. Each protrusion 950, 1050, and 1150 is arranged to create the surface of the sphere such that each protrusion 950, 1050, and 1150 touches another protrusion on at least two sides.

By way of example (and not limitation), twelve protrusions 950, 1050, and 1150 may be used for each lamp in a three lamp configuration. The surface of optical structures 900, 1000, and 1100 containing the second optical elements for each lamp may be further formed such that each plane substantially disposed over each lamp is tilted towards the central axis. The illustrations of FIGS. 9A-11C illustrate each plane of optical structures 900, 1000, and 1100 as breaks between protrusions 950, 1050, and 1150 corresponding to the placement and number the lamps for each respective optical structure. Accordingly, the protrusions 950, 1050, and 1150 are arranged such that the protrusions for each lamp are physically separated from the protrusions operably associated with other lamps of the same light source by a small flat surface of the optical structure containing no protrusions. The multiple projections of the second optical element causes a color mixing effect that results in a substantially uniformly white light, furthering a goal of the invention by preventing a yellow halo effect which occurs with non-mixed light sources.

A third optical element of each of the optical structures 900, 1000, and 1100 are disposed on the surfaces of the protrusions 950, 1050, and 1150 of the second optical elements. Although this microdiffusion texture is present on each of the optical structures 900, 1000, and 1100, the microdiffusion texture is shown only in the detail FIG. 10F. Third optical element is a microdiffusion texture 1060 that has the optical effect of a diffuser with a low scatter angle to further a goal of the invention of removing any remaining image and projection effects. Individual elements of the repeating circular texture of the microdiffusion texture 1060 each have a diameter preferably between 100 and 200 micron. For example, a microdiffusion texture creating a five degree scatter may preferably have a spherical height of 10-20 microns when created in an optical structure comprised of acrylic.

The combined effect of the three optical elements of the optical structure results in a substantially shadowless, substantially homogeneous, and substantially monochromatic light. The optical structure may contain additional optical elements. The optical structure may be used in tandem with one or more additional optical structures to provide further optical effects. The optical structure may be disposed within the housing, which is disposed in the light source. The optical structure may be in registration with a structure on which the lamps are disposed, such that the lamps are in registration with the first optical element.

FIG. 9D is a front view of mounted lamps 530 for use with the optical structure of FIG. 9A in accordance with the subject technology. FIG. 9E is a perspective view of the mounted lamps of FIG. 9D illustrating the connection to a driver circuit in accordance with the subject technology. Lamps 530 are disposed in a structure 910 that is electrically connected to driver circuit and PCB 960. PCB 960 is secured to structure 910 by threading tab 980 through slot 970. The layout of lamps 530 correspond with cavities 930 of FIG. 9C. Orientation of lamps is further maintained by aligning tab 995 of optical structure 900 with slot 990 of structure 910. Structure 900, PCB 960, and the number of lamps 530 can be varied in order to provide operating lamps and electrical components for a variety of numbers of lamps 530, for use with optical structures 1000 and 1100, among other variations.

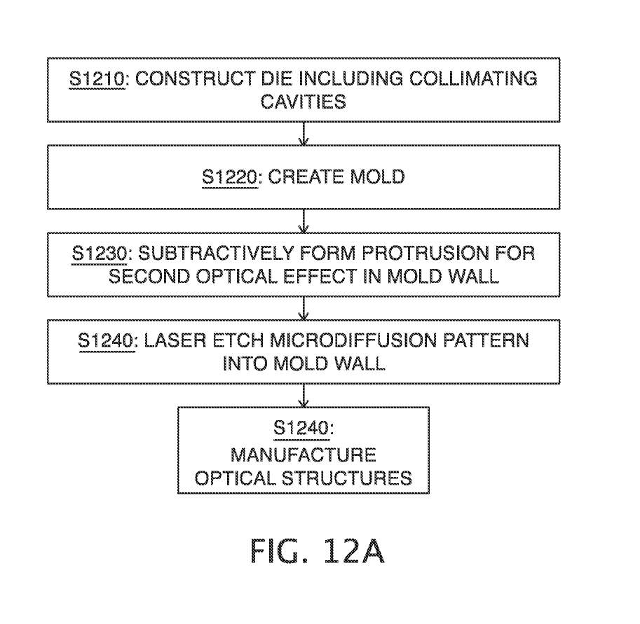

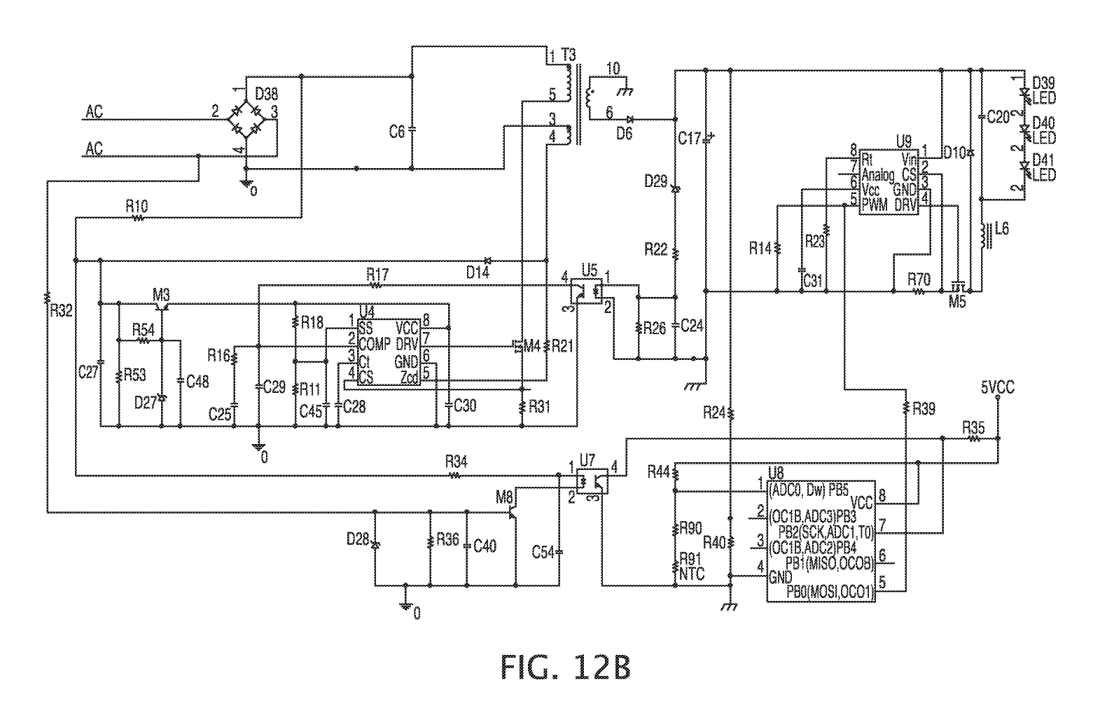

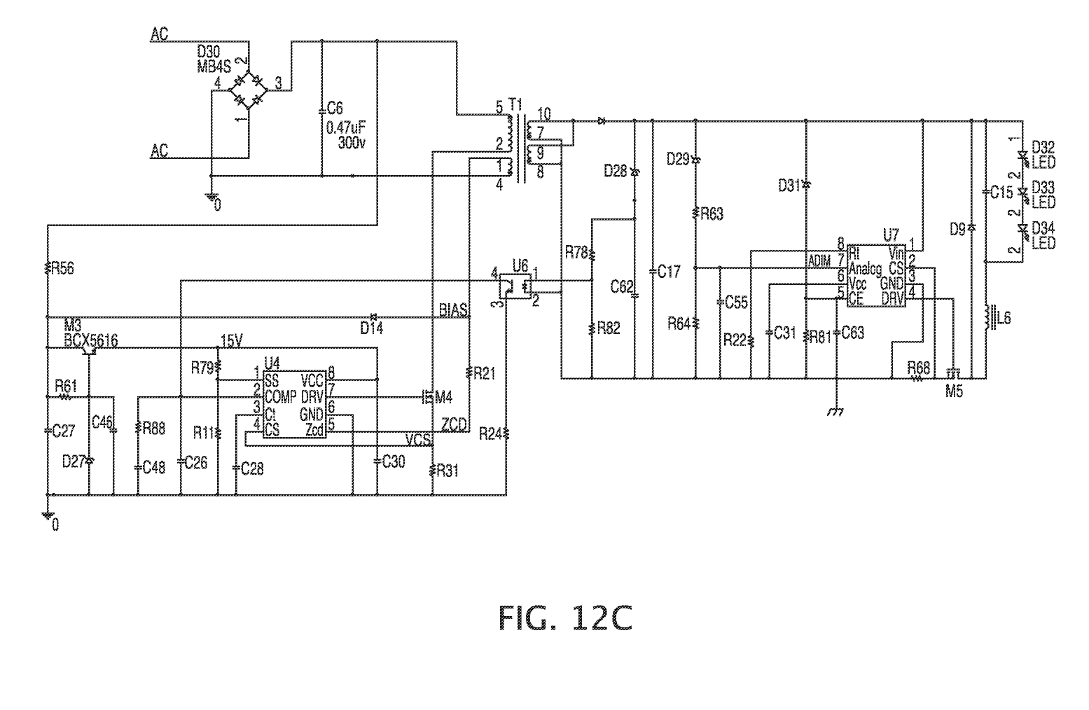

FIG. 12 is a flow chart illustrating a method for making the optical structure of FIGS. 9A-11C. The microdiffusion element is created in the injection mold process. The die is constructed in S1210 with the cavities 930, 1030, and 1130. The depth of the TIR cavity is determined to correspond with the desired optical effects. The angles and topography of the second optical element are determined by equations based in fractal geometry. The slope angle of the planes of the surface of second optical element are determined by the equations. The mold is then made from the die in S1220.

The topography of the second optical element is subtractively formed into the die using an electric discharge machining (EDM) process in S1230. Each protrusion 950, 1050, and 1150 is sized and shaped to provide a total spread of the light source. For example, the total spread of the light source may be configured to provide a fifteen degree spread, a twenty-four degree spread, a forty-five degree spread, or the like. These exemplary spread angles are generally achieved with optical equations. The spread angle of the resulting optical structure may be determined by measuring from a central axis to an outer edge of the light emitted from the optical structure. The size of the base and the number of protrusions may be chosen such that the light emitted from each lamp is substantially received by the input of the second optical element. Following an initial EDM process, sample optical elements may be produced and tested. Further refinement is performed to accommodate the individual materials and tools. Additional EDM processes and further testing are performed to achieve the desired spread.

The microdiffusion pattern is created in an inner surface of the mold by laser etching the diffusion pattern into the appropriate surface of the mold in S1240 such that the microdiffusion pattern will be integrally formed on the surface of the protrusions 950, 1050, and 1150 following creation of the mold. The topography of the microdiffusion texture may be determined based on fractal geometry equations.

The diffusion texture is integrally formed via laser in the optical structure through the injection mold process furthering yet another goal of efficient manufacture of the optical structure. The depth of the pattern is determined. One exemplary depth is 10-12 micron for a 100 micron diameter diverging beam, which provides a microdiffusion texture with 5-7 degree scatter. The divergence degree s(x) can be used to determine the vertex radius of curvature (R) where c=1/R and K is a conic constant:

$$s ( x ) = \frac{c {x}^{2}}{1 + \sqrt{1 - ( 𝒦 + 1 ) {c}^{2} {x}^{2}}}$$

The angles of the laser are dependent on the materials, temperature of the environment, and type of laser. The process of determining the appropriate angles of the laser can be determined through the resulting optical structures by using a measuring the light emitted from the optical structure using a laser of a known wavelength as the light source and taking optical measurements of the emitted light. Test patterns can be burned on a sample block of the same steel as the mold and measured for reflected beam scatter when sourced by a visible laser to determine laser settings. The 50% scatter angle needs to be greater from the tool as the structure will not be entirely transferred to the molded part, the percentage scatter angle is dependent on the mold materials. A laser surface path can be made using existing Rhinoceros® Software and implemented using GF AgieCharmilles® (GFAC) LASER 1200 5Ax. Prior to lasering the microdiffusion pattern, the mold cavity can be polished to a minor finish, with a machining index of a 0 or 1. Since the diffusion will also be on the mold cavity after laser processing, the laser energy can be based on the diffusion as reflected light image from the processed surface. Image transfer from the most to the plastic will be affected by shrinkage of the plastic during cooling as well as the mold flow of the plastic. Optical structures can then be manufactured in S1240 using the completed mold.

Once manufactured, the optical structures are checked for correct microdiffusion patterns both mechanically and optically. Mechanical checks may be performed by sectioning the part. A shallow microdiffusion pattern is indicative of a mold that has not been completely packed, or poor material image transfer indicating a need to revise the burn settings. Optical testing can be performed using a laser beam projected through the optical part at a screen to manually observe the resulting scatter pattern.

FIG. 12B is a schematic diagram of a driver circuit 1200 for use with some embodiments of the subject technology particularly where dimming of the light source must be controlled directly by the source voltage. It is understood that driver circuit 1200 can be modified and/or scaled for use with light sources with a variety of lamp loads. Driver circuit 1200 is operably connected to an AC mains power supply, which may provide a line voltage of 110-240V AC at a frequency of 50 or 60 Hz. The line voltage, AC, is applied across a full wave rectifier (D38). That line voltage may be adjusted by a thyristor-based dimmer 50 circuit. The thyristor-based dimmer circuit may preferably be a triode for alternating current (TRIAC) or a silicone control rectifier (SCR), but it is understood that other dimmer circuits may be used. While the dimmer circuit, itself, does not form part of the subject technology, by designing driver circuit 1200 to control dimming based on the available power (i.e. duty cycle of the AC input voltage) rather than trying to use the state of the thyristor or by monitoring the phase information on the input voltage, the subject technology has been designed to work with a broad range of commercially available dimming circuits. Driver circuit 1200 has three sub-sections: (a) an AC-to DC power converter circuit 1210; (b) a sine wave edge detector 1220; and (c) an adjustable constant current source circuit 1250.

The AC-to-DC power converter circuit 1210 receives the alternating current (AC) line voltage, which can be thought to have a duty cycle that may be varied by a dimmer circuit (not shown) such that the duty cycle of the AC line voltage would be approximately 100% where there is no dimmer circuit or the dimmer is full on and, thus, not altering the firing phase angle. The AC-to-DC power converter circuit 1210 not only converts from alternating to direct current, but is designed to convert VA (volts/Amps) into a DC power with peak watts where the AC conversion is set to meet the load requirement for 2-3 solid state light sources at minimum input voltage. A capacitor C6 is a filter cap for the transformer T3.

Transformer T3 in circuit 1200 is a flyback transformer because of the higher energy storage with large variation of input voltage capabilities in the magnetic circuit provided by that type of transformer. When combined with switch M4 for voltage spike suppression T3 can re-circulate its stored power back into the full wave DC that is then applied to the transformer on the next switch cycle. This results in a small boost (mostly when the input voltage is below the secondary voltage times the turns ratio of T3) providing the additional voltage to the flyback transformer for power transfer even at low AC phase angles and when the dimmer has a low DC offset. As shown in FIG. 12, a power factor correction circuit 1205 may also be included and particularly preferred where T3 is a flyback transformer. In particular, power factor correction circuit 1205 may be designed around U4 (which may preferably be a NCL30000 power factor corrected dimmable LED Driver with switch mode power supply). Still, any transformer may be utilized with the understanding that lesser power efficiencies may be achieved than with the preferred circuit specifically disclosed.

On the secondary of transformer T3 (FIG. 12B), a DC power output is produced with a ripple voltage. The DC secondary includes capacitance (i.e. C17) that is sized to have a higher voltage than the series voltage of the three LEDs (D39, D40, and D41). Since solid state lamps operate in a fixed voltage range at a fixed line frequency, the ripple across this capacitance can be determined when a known power load (i.e., a lamp load) is applied. The ripple voltage has a ratiometrically determined magnitude that is determined by the duty cycle of the dimmed AC line voltage and the lamp load. LED Driver U9 is preferably a CPC9909 manufactured by Clare, Inc. (www.clare.com). This chip may be thought of as a cycle-by-cycle current limiter. However, as those of ordinary skill in the art having the present specification before them would understand, other regulators may be used. The CPC9909 has a dedicated input for a low-frequency pulse width modulated dimming control signal, which is operably connected to the output of the microprocessor U8. The LED driver U9 varies the current delivered by the constant current circuit to the lamp load based on the values of the signals from the dimming control circuit applied to the gates marked PWMD (pulse width modulation input) and CS (current sense). The input to the CS pin is the current flowing through the lamp load presented as the voltage drop across R70. U9 uses this CS value to turn on and off M5 in order to maintain the peak current across the LEDs D39, D40, and D41 to avoid color shifting the LEDs.

The dimming control circuit 1220 receiving input power having a duty cycle and a maximum output power value and outputting a dim control signal based on the duty cycle of the input power and the maximum output power value. In a preferred embodiment, the dimming control circuit 1220 is based on a programmed 8-bit microprocessor, U8, such as the ATtiny25 (an 8-bit AVR RISC-based microcontroller combines 2 KB ISP flash memory, 128B EEPROM, 128B SRAM with general purpose I/O lines, general purpose working registers, an 8-bit timer/counter (with compare mode), 8-bit high speed timer/counter, external/internal interrupts, and an A/D converter).

Microprocessor U8 is programmed with code that provides the ability to dim the solid-state lights by thyrister dimming (e.g. triac), 0-10V analog and series digital signals by one or more sources where the fixture is self-configuring to respond to multiple diming signals. This ability allows a building control (not shown) to set a maximum dimming level and still allow the local dimming of individual fixtures and/or rooms by local thyrister-based wall dimmers. This dual control enables load shed controlling by the building controls and still allows users to dim conference rooms /offices when required.

The interface to the building control uses a standard analog signal (0-10 v) or digital protocols which can be wired or wireless (e.g. zigbee, DALI, DMX). The building control signal is read to determine the maximum percentage dimming. The maximum set point established by the building control is compared to the phase dimming signal created by measurement of the AC waveform. In particular, the input AC signal is received as a half or full wave rectified signal. The rectified signal is placed thru a comparator set to the highest typical hold voltage for Triac dimmers. The square wave generated contains the dimming percentage as a width change on the waveform. This waveform is passed to the microcontroller U8, which is shown as being optically isolated from the circuit by opto-coupler U7. It should be understood by those of ordinary skill in the art having the present specification before them that microcontroller U8 may be non-isolated. Using this resulting waveform as an edge trigger microprocessor U8 counts the number of present timer intervals. This count is used to determine the phase diming.

The set point determined in from the building control is compared to the phase diming percentage count, whichever is lower is used to set the pulse width modulated diming. The building lighting control always maintains the peak illumination for both load shedding and occupancy time. The end points are where phase diming is 100% on and the building diming is 1%, here the AC-to-DC conversion is functioning normal with the feedback in control. The other extreme is the phase diming is 5% and the building diming is 100% on. For this the PWM needs to respond quickly to reduce the chance of LED flicker. Since the power in the AC mains may drop faster than the circuit can “dim-down” the circuit—using the averaging approach adopted in the circuitry—when the secondary bulk DC drops below an expected minimum voltage, the PWM moves to less than the phase angle value. Once the voltage recovers the LED will increase level to the percentage determined.

A local occupancy sensor can be another input as a switch toggle along with a local ambient light sensor. The occupancy toggle will define the PWM as max or off. Like the prior comparison this data can also be compared. The same is held for the light sensor which can also provide a signal that dims the led by providing the lowest diming percentage. An

example of the hierarchal dimming working in a priority, the highest is the occupancy sensor, next phase diming, then ambient light and last building diming.

The ability to dim individual LED drivers exists but can create issues in fixtures where multiple LED drivers exist that can dim parts of fixtures. Where the dimming signal is digital, analog or phase diming the individual LED drivers may convert the dimming data provided into different LED drive currents where the result is each led segment can be at a different illumination level when diming occurs. This can occur with any of the dimming control method, the method with the most error is phase diming as this is not an absolute signal but a signal derived from the manipulation of the AC phase. To correct for this issue communication between LED drivers could be added at a fixture level to provides direct control over the LED drive current. This communication is the drive current data and not the higher level building data or phase data, as the drivers may be controlled by multiple dimming methods 0-10, DALI, Zigbee, Occupancy sensor, the LED drive current can be controlled at the lowest level with one driver determining the diming from one or multiple sources and the remaining driver listening and responding only.

As phase dimming begins the average of the ripple begins to drop as seen across the DC output capacitance (i.e. C17) since the load is constant at this point. Once the six cycle average drops below the set point, the LED drive current is reduced. In reality, because there is a tolerance on the capacitance and a few other set point determining components the drive current may not change for 10-20 degrees of phase dimming, and this is required to ensure peak lumen output occurs on all lamps. As the average drops followed by a drop in the LED current, the system will begin to attain a median point and the LED drive current will become proportional to the ripple.

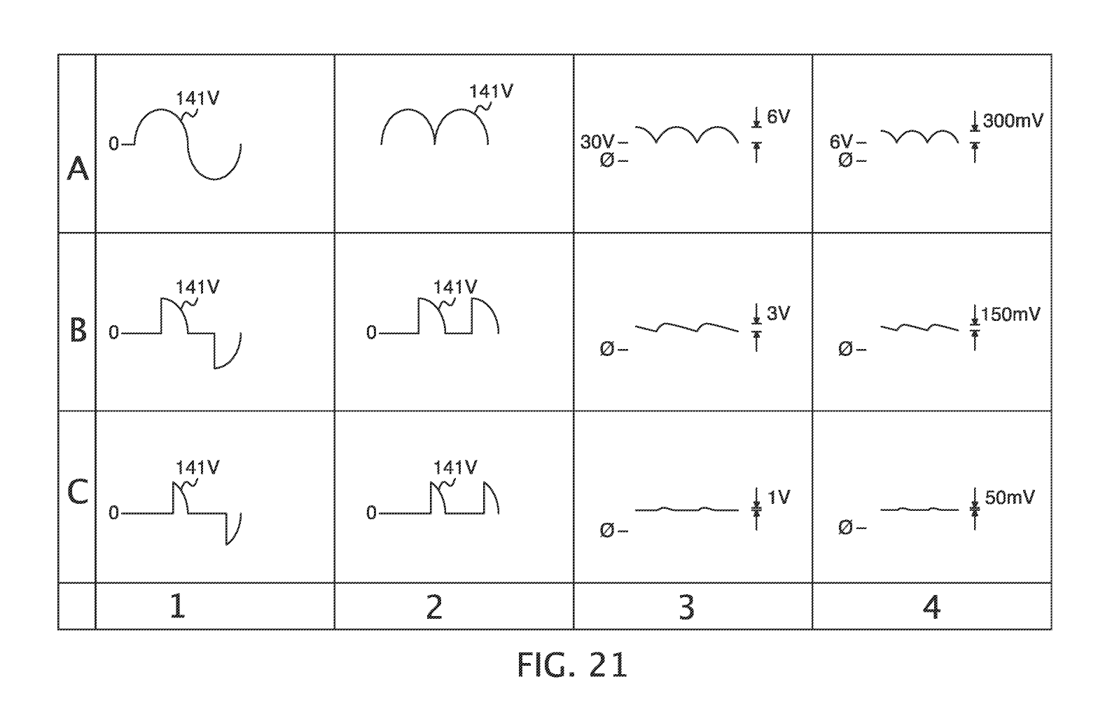

FIG. 12C is a schematic diagram of a driver circuit 2200 for use with some embodiments of the subject technology particularly where dimming of the light source must be controlled directly by the source voltage. It is understood that driver circuit 2200 can be modified and/or scaled for use with light sources with a variety of lamp loads. Driver circuit 2200 is operably connected to an AC mains power supply, which may provide a line voltage of 110-120V AC at a frequency of 50 or 60 Hz. The line voltage, AC, is applied across a full wave rectifier (D30). As shown by comparing cell 1A to 1B and 1C in FIG. 21, that line voltage may be adjusted by a thyristor-based dimmer circuit (not shown). The thyristor-based dimmer circuit may preferably be a triode for alternating current (TRIAC) or a silicone control rectifier (SCR), but it is understood that other dimmer circuits may be used. While the dimmer circuit, itself, does not form part of the subject technology, by designing driver circuit 2200 to control dimming based on the available power (i.e. duty cycle of the AC input voltage) rather than trying to use the state of the thyristor or by monitoring the phase information on the input voltage, the subject technology has been designed to work with a broad range of commercially available dimming circuits. Driver circuit 2200 has three sub-sections: (a) an AC-to DC power converter circuit 2210; (b) a sine wave edge detector 1220; and (c) an adjustable constant current source circuit 2250; and

The AC-to-DC power converter circuit 1210 receives the alternating current (AC) line voltage, which can be thought to have a duty cycle that may be varied by a dimmer circuit (not shown) such that the duty cycle of the AC line voltage would be approximately 100% where there is no dimmer circuit or the dimmer is full on and, thus, not altering the firing phase angle. The AC-to-DC power converter circuit 1210 not only converts from alternating to direct current, but is designed to convert VA (volts/Amps) into a DC power with peak watts where the AC conversion is set to meet the load requirement for 2-3 solid state light sources at minimum input voltage. A capacitor C6 is a filter cap for the transformer T3.

Transformer T3 in circuit 1200 is a flyback transformer because of the higher energy storage capabilities in the magnetic circuit provided by that type of transformer. When combined with switch M4 for voltage spike suppression T3 can re-circulate its stored power back into the full wave DC that is then applied to the transformer on the next switch cycle. This results in a small boost (mostly when the input voltage is below the secondary voltage times the turns ratio of T3) providing the additional voltage to the flyback transformer for power transfer even at low AC phase angles and when the dimmer has a low DC offset. As shown in FIG. 12, a power factor correction circuit 1205 may also be included and particularly preferred where T3 is a flyback transformer. In particular, power factor correction circuit 1205 may be designed around U4 (which may preferably be a NCL30000 power factor corrected dimmable LED Driver with switch mode power supply). Still, any transformer may be utilized with the understanding that lesser power efficiencies may be achieved than with the preferred circuit specifically disclosed.

On the secondary of transformer T3 (FIG. 12B), a DC power output is produced with a ripple voltage. The DC secondary includes capacitance (i.e. C17) that is sized to have a higher voltage than the series voltage of the three LEDs (D39, D40, and D41). Since solid state lamps operate in a fixed voltage range at a fixed line frequency, the ripple across this capacitance can be determined when a known power load (i.e., a lamp load) is applied. The ripple voltage has a ratiometrically determined magnitude that is determined by the duty cycle of the AC line voltage and the lamp load. LED Driver U9 is preferably a CPC9909 manufactured by Clare, Inc. (www.clare.com). This chip may be thought of as a cycle-by-cycle current limiter. However, as those of ordinary skill in the art having the present specification before them would understand, other regulators may be used. The CPC9909 has a dedicated input for a low-frequency pulse width modulated dimming control signal, which is operably connected to the output of the microprocessor U8. The LED driver U7 varies the current delivered by the constant current circuit to the lamp load based on direct analog feedback (see ADIM in FIG. 12C) applied to the gate marked “Analog” (see FIG. 12C), CE (chip enable) and CS (current sense). The direct analog feedback loop travels through Zener diode D29 to subtract some of the voltage out of the circuit. Feedback from the input waveform is also applied to the secondary circuit via an optacoupler U6 across a voltage divider circuit (R78/R82) and through D28. The input to CE is the voltage supplied to the LEDs, which prevents LED driver U7 from switching on until the voltage across C17 is at least greater than the voltage across C17. The input to the SE pin is the current flowing through the lamp load presented as the voltage drop across R70. U9 uses this CS value to turn on and off M5 in order to maintain the peak current across the LEDs D39, D40, and D41 to avoid color shifting the LEDs.

The circuitry in FIG. 12C causes a ripple leading to self-oscillation that remains controlled through the application of the CE signal. In all, this helps the circuit provide a soft start type mechanism to the LEDs.

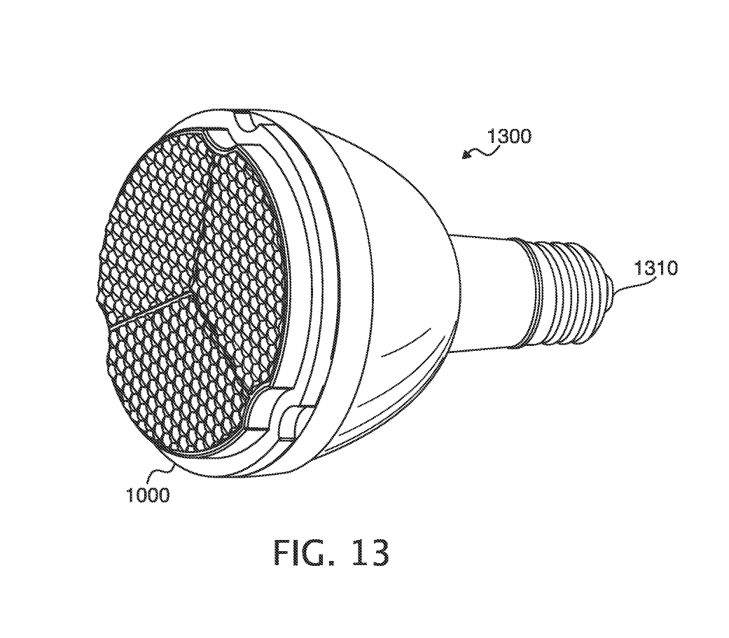

FIG. 13 is a perspective view of a housing 1300 for the optical structure of FIGS. 10A-10D in accordance with the subject technology. The housing 1300 includes an Edison-type base. The optical structures, PCB, lamps, and optical structures illustrated in FIGS. 9A-11C may be disposed within housing 1300. The optical structure 1000 may be alternatively formed such that it screws into a threaded opening of the housing such that the driver circuit and lamps are substantially sealed within the housing. Optical structure 1000 may be joined with housing 1300 with a pressure fit or any other known mechanical fitting. Housing 1300 may be constructed with an electrical contact 1310, such that it may screw into an electrical socket.

FIG. 14A is a top plan view of PCB 520 of FIG. 5 roughly illustrating a driver circuit in accordance with the subject technology. Among other components, PCB 520 includes the driver circuit 1430 disposed between heat conducting strips 580. When fastened to heat sink 112, driver circuit 1430 faces a back wall of the cavity of the heat sink 112. PCB 520 may be constructed of any length (presently 1′ and/or 2′ are believed to be preferred). PCB 520 may be joined with other PCBs to form light sources of any length, and alignment of one PCB 520 with another PCB may be provided with connecting ends 1410a and 1410b. As illustrated, two male connecting ends 1410a are integrally formed in one end, and two female connecting ends 1410b are formed in the opposing end. Alternatively, one male and one female connecting end may be provided on opposing ends, or connectors may be discrete components that fix together multiple PCBs without the need for integrally formed connecting ends.

FIG. 14B is a perspective view of two PCBs 520 (labeled 1440a and 1440b) that have been joined together in accordance with the subject technology. PCBs 1440a and 1440b are mechanically joined by connecting ends 1410a and 1410b. PCBs 1440a and 1440b are electrically connected through ribbon cables 510 which allow operation of connected PCBs with a single connection to an exterior power source. A resistor 1420 may be further be embedded in ribbon cable 1420 to provide maximum power limitations.

FIG. 14C is a bottom plan view of PCB 520 illustrating a layout of lamps 530 disposed in PCB 520 in accordance with the subject technology. Lamps 530 are disposed on the opposite side of the driver circuit 1430 of PCB 520 in a substantially evenly-spaced, linear fashion. Lamps 530 nearest the connectable ends of PCB 520 are disposed such that the space of the last lamp from the end is approximately half the space between two lamps. Such spacing of the lamps furthers a goal of the invention of providing even and uniform illumination at any length and enhances the interchangeability of various components of the light sources. As illustrated in FIGS. 14A and 14B, lamps may be disposed on multiple PCBs that may be mechanically and operably linked together to form a longer linear light source. It is preferably that the lamps disposed on abutting ends of multiple PCBs are separated by the same fixed distance as the fixed distance between lamps disposed on a single PCB.

FIG. 14D is a bottom plan view of another embodiment of a PCB of alterable length in accordance with the subject technology. Alternative embodiments of PCB 520 include PCBs of alterable length. Accordingly, PCBs of various standard sizes can be further customized to provided light sources of customized lengths. For example, the PCB may be similarly constructed to PCB 520 and further include a series of additional lamps on one end of the PCB. Between each additional lamp, the PCB may be frangible by pre-scoring the PCB at regular intervals so that the PCB may be broken to adjust the length and number of lamps. In such cases, the PCB physical layout would be such that the driver circuit 1430 is disposed on a portion of the PCB that is not frangible. FIG. 14E is a bottom plan view of the alterable length PCB of FIG. 14D after reducing the length of the PCB in accordance with the subject technology.

FIG. 15 is a schematic diagram of a driver circuit 1500 for use with some embodiments of the subject technology particularly where dimming of the light source must be controlled directly by the source voltage. It is understood that driver circuit 1500 can be modified and/or scaled for use with light sources with a variety of lamp loads. Driver circuit 1500 is operably connected to an AC mains power supply, which may provide a line voltage of 110-240V AC at a frequency of 50 or 60 Hz. The line voltage is applied to driver circuit 1500 at terminals J1 and J2 (FIG. 15). That line voltage may be adjusted by a thyristor-based dimmer 50 circuit. The thyristor-based dimmer circuit may preferably be a triode for alternating current (TRIAC) or a silicone control rectifier (SCR), but it is understood that other dimmer circuits may be used. While the dimmer circuit, itself, does not form part of the subject technology, by designing driver circuit 1500 to control dimming based on the available power (i.e. duty cycle of the AC input voltage) rather than trying to use the state of the thyristor or by monitoring the phase information on the input voltage, the subject technology has been designed to work with a broad range of commercially available dimming circuits. Driver circuit 1500 has three sub-sections: (a) an AC-to DC power converter circuit 1510; (b) a peak detector circuit 1520; and (c) an adjustable constant current source circuit 1550.

The AC-to-DC power converter circuit 1510 receives the alternating current (AC) line voltage, which can be thought to have a duty cycle that may be varied by the dimmer circuit 50 such that the duty cycle of the AC line voltage would be approximately 100% where there is no dimmer circuit or the dimmer is full on and, thus, not altering the firing phase angle. The AC-to-DC power converter circuit 1510 not only converts from alternating to direct current, but is designed to convert VA (volts/Amps) into a DC power with peak watts where the AC conversion is set to meet the load requirement for 2-3 solid state light sources at minimum input voltage.

The AC-to-DC power converter circuit 1510 has an input stage running from terminals J1 and J2 to the primary windings of transformer T1. The primary is preferably designed to keep the full bridge rectifier in a forward conducting mode to increase the power efficiency of the circuit. Inductance L5 and L7 in combination with capacitor C6 form a non-dissipating snubber circuit.

Transformer T1 in circuit 1500 is preferably a flyback transformer because of the higher energy storage capabilities in the magnetic circuit of that type of transformer. When combined with switch M4 for voltage spike suppression T1 can re-circulate its stored power back into the full wave DC that is then applied to the transformer on the next switch cycle. This results in a small boost (mostly when the input voltage is below the secondary voltage times the turns ratio of T1) providing the additional voltage to the flyback transformer for power transfer even at low AC phase angles and when the dimmer 50 has a low DC offset. As shown in FIG. 15, a power factor correction circuit 1505 may also be included and particularly preferred where T1 is a flyback transformer. In particular, power factor correction circuit 1505 may be designed around U4 (which may preferably be a NCL30000 power factor corrected dimmable LED Driver with switch mode power supply). Still, any transformer may be utilized with the understanding that lesser power efficiencies may be achieved than with the preferred circuit specifically disclosed.

On the secondary of transformer T1, a DC power output is produced with a ripple voltage. As such, the DC secondary includes capacitance (i.e. C17 and C57) that is sized to create a determinable ripple when the AC input voltage and the solid state light load are both at their maximum (e.g. 2-3 LEDs). Since solid state lamps operate in a fixed voltage range at a fixed line frequency, the ripple across this capacitance can be determined when a known power load (i.e., a lamp load) is applied. The ripple voltage has a ratiometrically determined magnitude that is determined by the duty cycle of the AC line voltage and the lamp load. The ripple is low pass filtered by C2 and R2 to remove all switch-mode noise and switching mode voltage transients from the ripple voltage. This voltage is the supply voltage to voltage regulator U9. Preferably, voltage regulator U9 is a high-current voltage regulator from the L78L00 family manufactured by STMicroelectronics. However, as those of ordinary skill in the art having the present specification before them would understand, other regulators may be used.

The peak detector circuit 1520 receives the filtered DC power output from the secondary of transformer from the AC to DC power converter circuit. In the embodiment shown in FIG. 15, the peak detector circuit comprises op-amp U9 and its associated biasing components R59/R65/R82/C58 configured such that the peak detector circuit removes the DC offset (equal to the forward voltage of the solid-state lamps being driven by circuit 1500) from the DC voltage produced by the AC-to-DC power converter circuit, only the ripple voltage component of that output effectively remains. This signal is averaged over 6 or more cycles; the average is the amount of energy that is available for the LED to be driven. The higher the average the brighter the LED, up to a maximum as set by the LED current driver U7.

As phase dimming begins the average of the ripple begins to drop as seen across the DC output capacitance (i.e. C17/C57) since the load is constant at this point. Once the six cycle average drops below the set point, the LED drive current is reduced. In reality, because there is a tolerance on the capacitance and a few other set point determining components the drive current may not change for 10-20 degrees of phase dimming, and this is required to ensure peak lumen output occurs on all lamps. As the average drops followed by a drop in the LED current, the system will begin to attain a median point and the LED drive current will become proportional to the ripple.

Since the dimming can occur faster than the six cycle limit there is a bucking diode, D49, that will conduct when the ripple average begins to drop by more than one volt from the peak average. The inclusion of this bucking diode is not required, but it does improve the dim down rate to better match the change in AC power available during a change in phase dimming. The diode (which may be a Zener) can be selected as desired to increase the diming down ramp. In circuit 1500 the nominal values have been preferably selected to result in a 33% minimum rate of change. Any change beyond that value will be handled by the diode with a rapid reduction in LED drive current.

In the converse case where the illumination is being increased, there is no need for any quick change feature. The average may be simply updated and the drive current increased. As before if the LED drive current begins to draw excessive current from the integrating capacitor the average reduces and then the LED drive current reduces.

The constant current circuit 1550 receives the output of the peak detector circuit 1520 and the current flowing through the lamp load, which is operably connected to the driver circuit 1500 via terminals J3 and J4. The constant current circuit 1550 is implemented in driver circuit 1500 by LED Driver U7. LED Driver U7 is preferably a CPC9909 manufactured by Clare, Inc. (www.clare.com). The CPC9909 has a dedicated input for a low-frequency pulse width modulated dimming control signal, which is operably connected to the output of the peak detector circuit. The current flowing through the lamp load is presented to the microprocessor as the voltage drop across R68. The microprocessor varying the current delivered by the constant current circuit to the lamp load based on the ripple component.

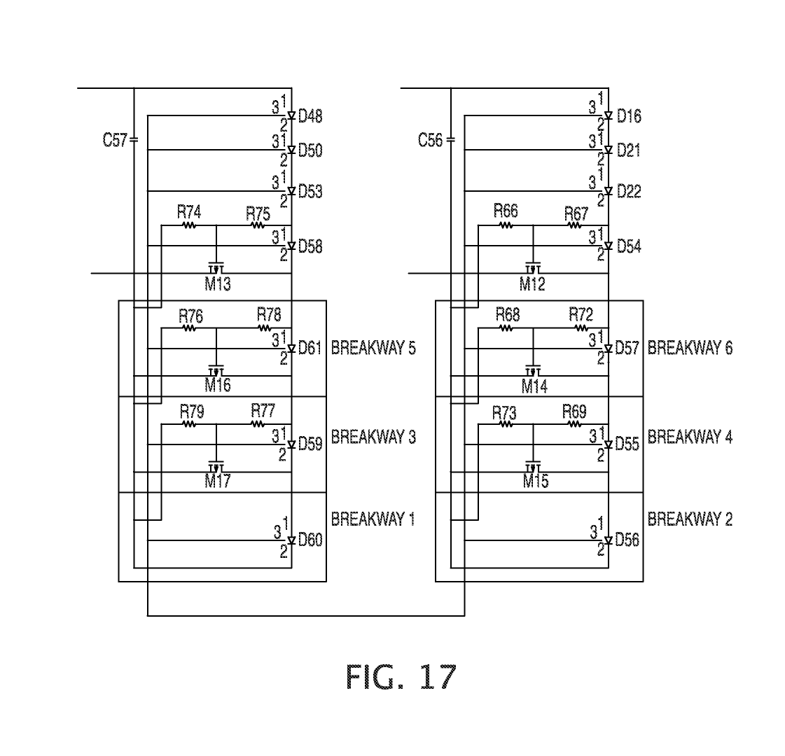

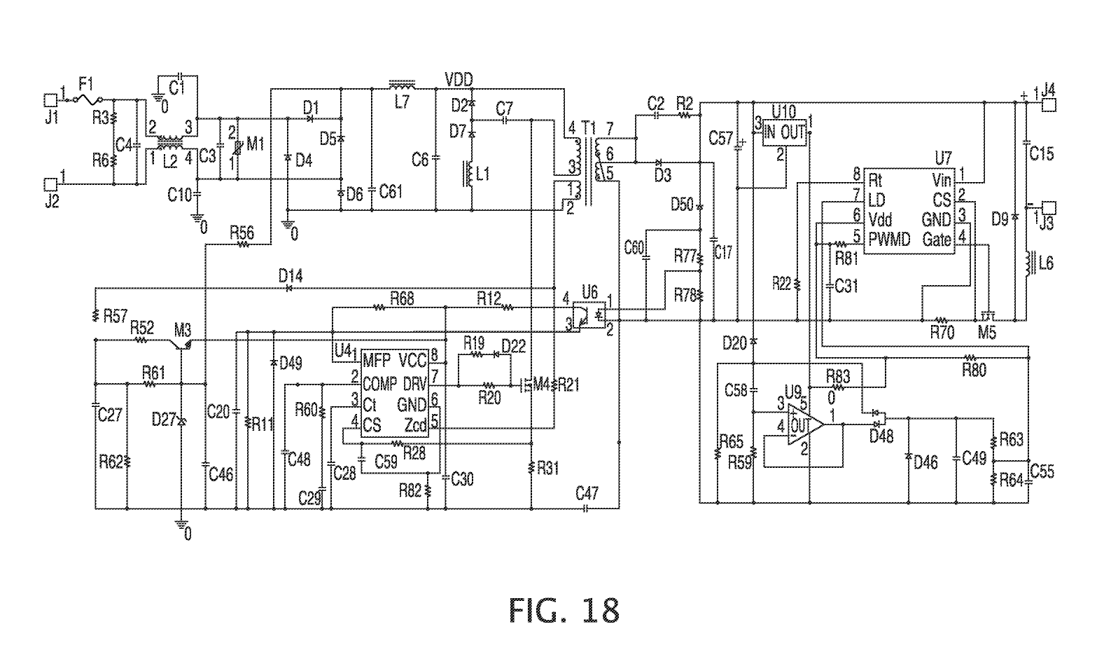

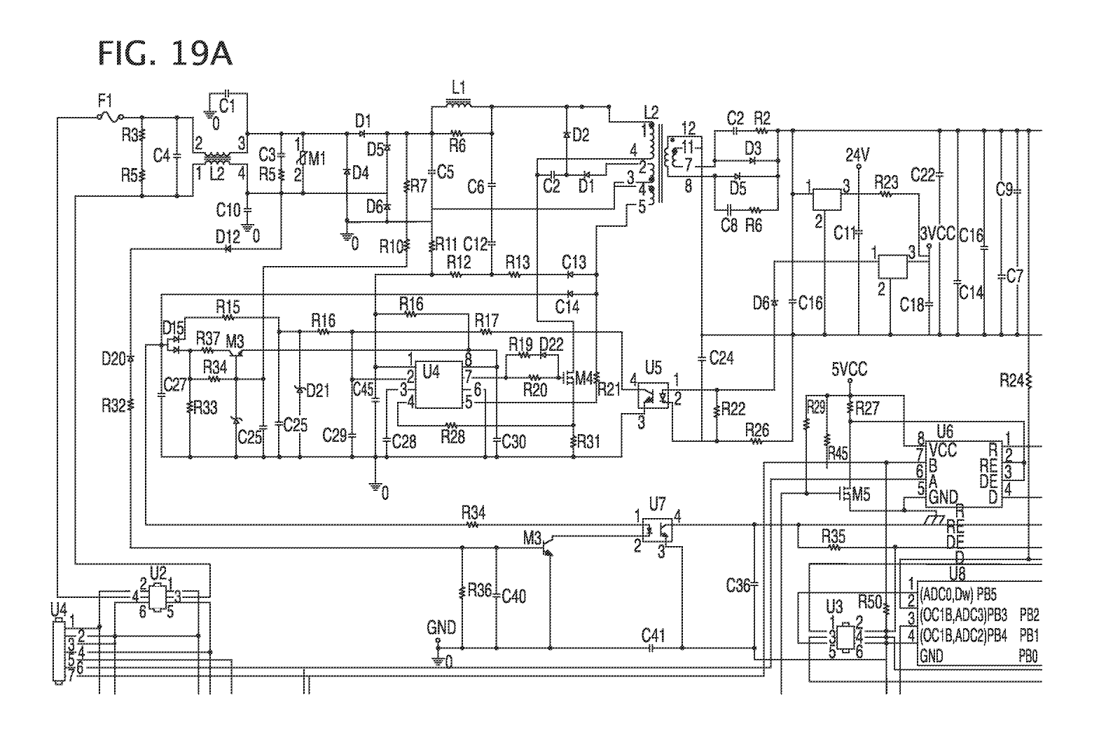

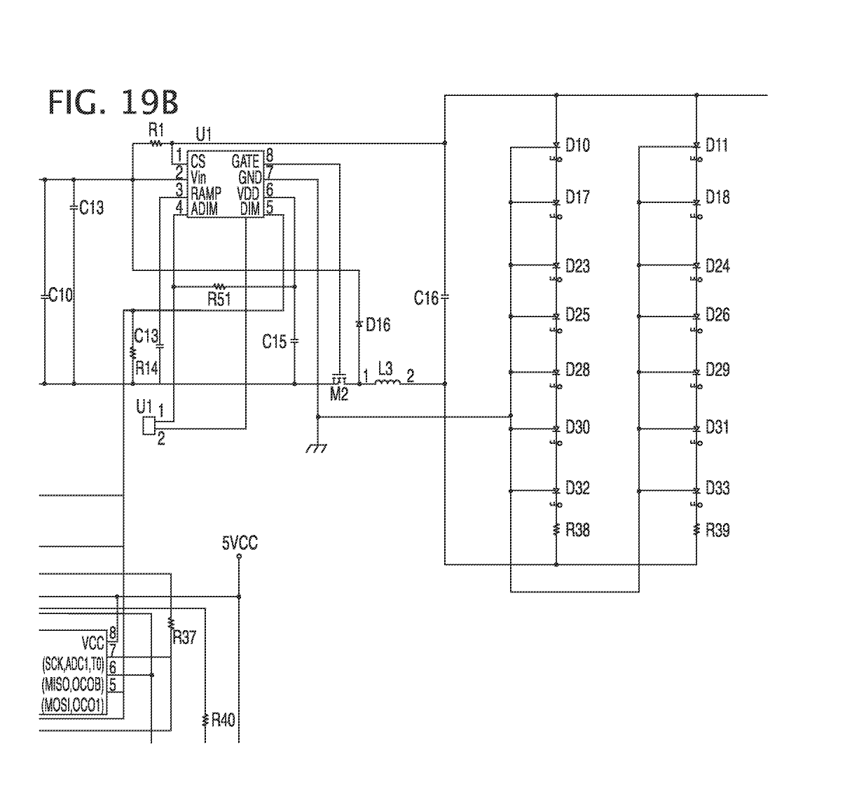

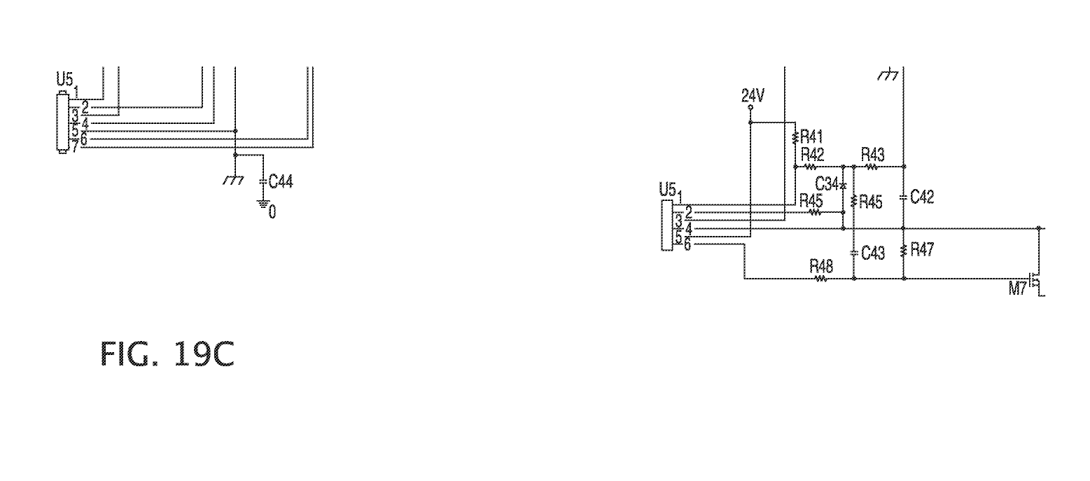

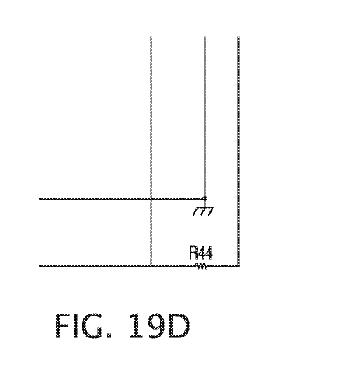

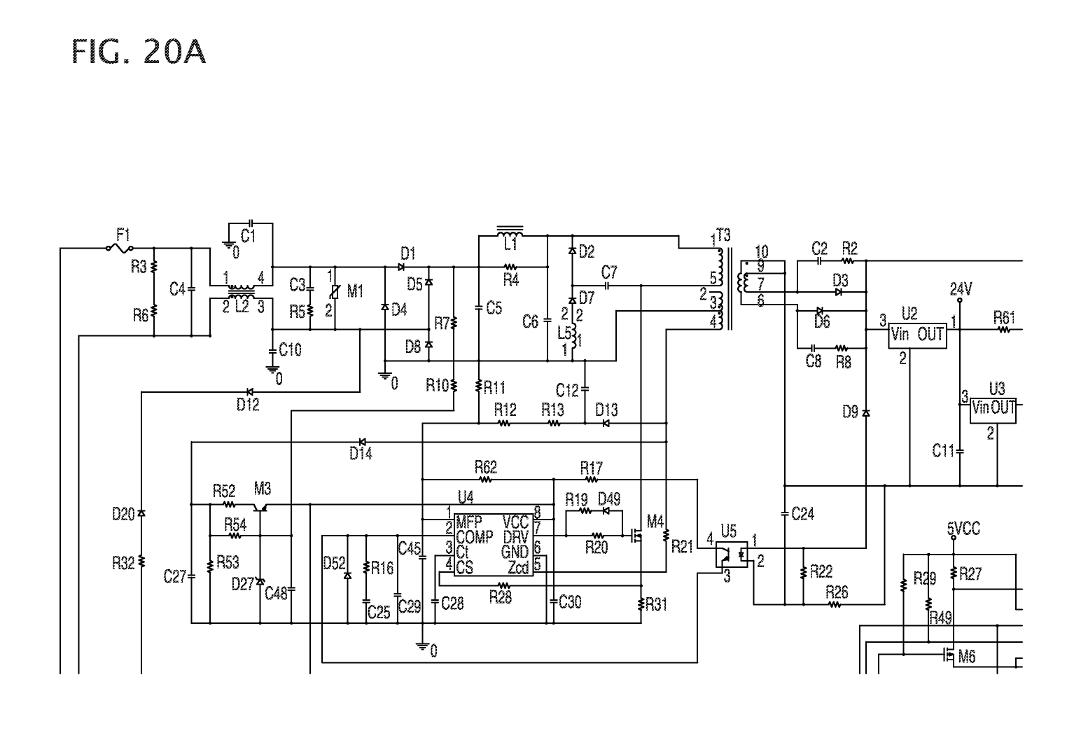

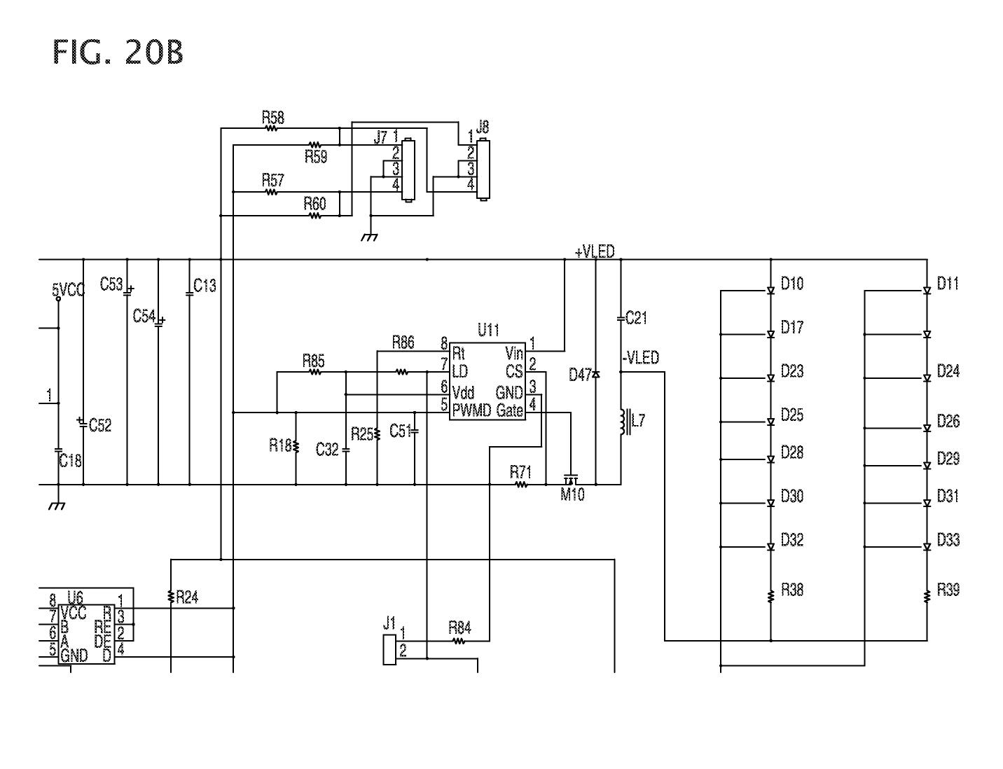

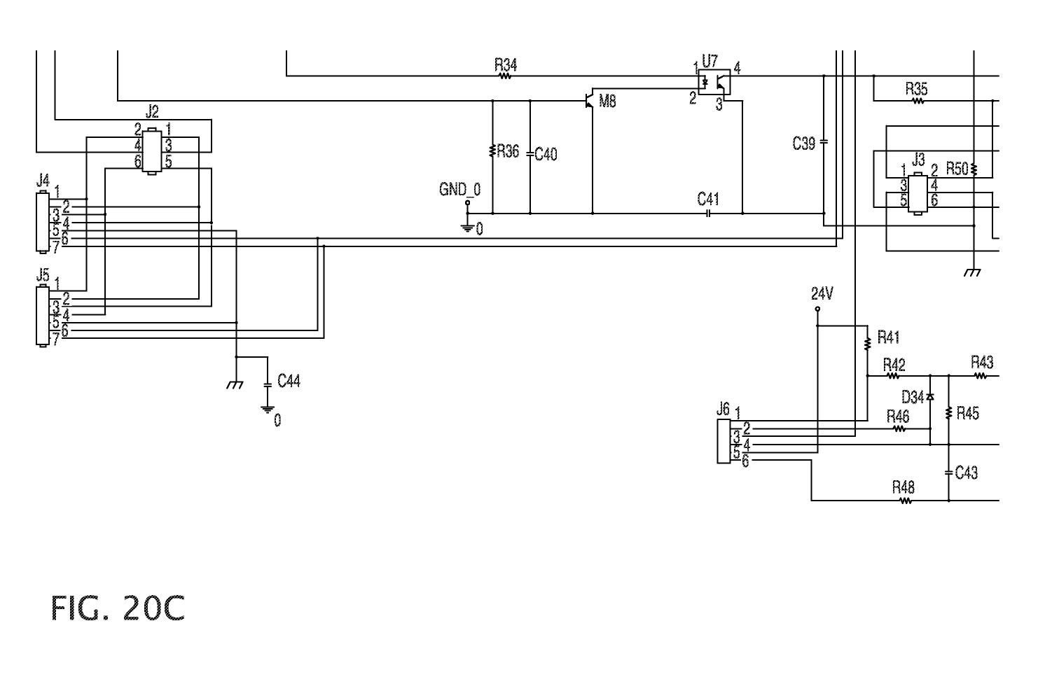

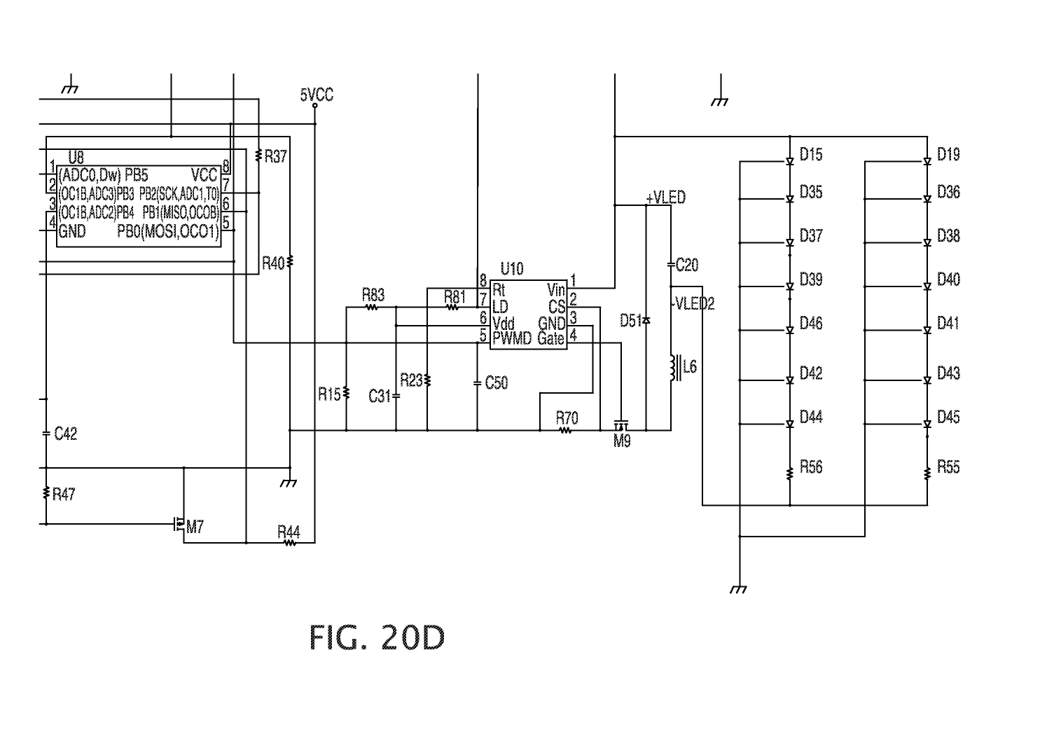

FIG. 17 is a schematic diagram depicting the electrical operation of the frangible PCB embodiment. In particular, solid-state light sources D16, D21, D22, D48, D50, D53, D54 and D58 may be permanently connected to a driver circuit, such as driver circuit 1600. Solid-state light sources D55, D56, D57, D59, D60, and D61 are disposed on break away portions of the PCB (see FIG. 14) as denoted by “BREAKWAY” 1-6. As discussed above by provide a pre-perforated, frangible line on the PCB, an installer in the field may modify the length of PCB. As shown, by biasing MOSFET switches M12 through M17 using the forward voltage of an associated LED as divided across the associated voltage dividers formed by R66 and R67; R68 and R72; R73 and R69; R74 and R75; R76 and R78; and R79 and R77, when an LED is removed from the circuit, the gate on the associated MOSFET is not biased so the FET no longer conducts effectively terminating the circuit before the section where the LED was removed.

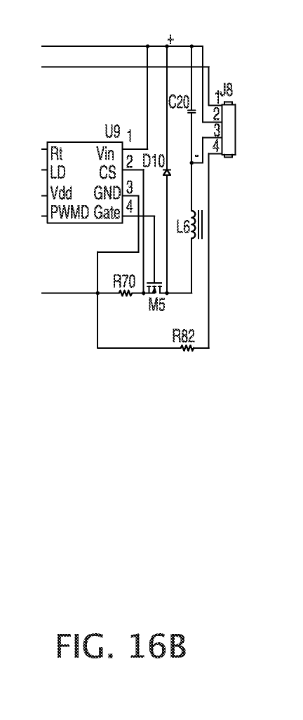

FIGS. 16A and 16B together provide a schematic diagram of driver circuit 1600 for use with some embodiments of the subject technology. Driver circuit 1600 is operably connected to an AC mains power supply, which may provide a line voltage of 110-240V AC at a frequency of 50 or 60 Hz. The line voltage is applied to driver circuit 1600 via ribbon cable input J5 (in the lower left hand corner of FIG. 16A). Driver circuit 1600 has three sub-sections: (a) an AC-to DC power converter circuit 1610; (b) a dimming control circuit 1620; and (c) an adjustable constant current circuit 1650.

The AC-to-DC power converter circuit 1610 receives the alternating current (AC) line voltage, which has an input stage running from fuse F1 to the primary windings of transformer T3. Two full-bridge rectifier (formed by D8/D5/D4/D1) supply a full wave rectified DC voltage to the primary of T3 through a non-dissipating snubber circuit formed by inductors L5 and L7 in combination with capacitor C6. The primary of transformer T3 is preferably operably connected to a power factor correction circuit 1605 through semiconductor switch M4. In particular, power factor correction circuit 1605 may be designed around U4 (which may preferably be a NCL30000 power factor corrected dimmable LED Driver with switch mode power supply).

On the secondary of transformer T3, the DC power output is fed through a low-pass filter (formed by C2 and R2) to substantially remove switch-mode noise and switching mode voltage transients. This filtered DC output power supplies voltage to voltage regulator U2 that produces a 12V supply, which in turn supplies voltage regulator U3 that produces a 5V supply. Preferably, voltage regulators U2 and U3 are both from the L78L00 family manufactured by STMicroelectronics. As would be understood by those of ordinary skill in the art having the present specification before them would understand, other regulators may be used and other voltages may be provided.

The DC power output from the secondary of transformer T3 is also used to drive the constant current circuit 1650. Constant current circuit 1650 receives the output of the dimming control circuit 1620 and the current flowing through the lamp load, which is operably connected to the driver circuit 1600 via terminals 2 and 4 of jumper J8. The constant current circuit 1650 is implemented in driver circuit 1600 primarily by LED Driver U9. LED Driver U9 is preferably a CPC9909 manufactured by Clare, Inc. (www.clare.com). The CPC9909 has a dedicated input for a low-frequency pulse width modulated dimming control signal, which is operably connected to an output of the dimming control circuit. The current flowing through the lamp load is presented to U9 as the voltage drop across R70. The LED driver U9 varies the current delivered by the constant current circuit to the lamp load based on the values of the signals from the dimming control circuit applied to the gates marked PWMD (pulse width modulation input) and LD (linear dimming).

The dimming control circuit 1620 receiving input power having a duty cycle and a maximum output power value and outputting a dim control signal based on the duty cycle of the input power and the maximum output power value. In a preferred embodiment, the dimming control circuit 1620 is based on a programmed 8-bit microprocessor, U8, such as the ATtiny25 (an 8-bit AVR RISC-based microcontroller combines 2 KB ISP flash memory, 128B EEPROM, 128B SRAM with general purpose I/O lines, general purpose working registers, an 8-bit timer/counter (with compare mode), 8-bit high speed timer/counter, external/internal interrupts, and an A/D converter).

Microprocessor U8 is programmed with code that provides the ability to dim the solid-state lights by thyrister dimming (e.g. triac), 0-10V analog and series digital signals by one or more sources where the fixture is self-configuring to respond to multiple diming signals. This ability allows a building control (not shown) to set a maximum dimming level and still allow the local dimming of individual fixtures and/or rooms by local thyrister-based wall dimmers. This dual control enables load shed controlling by the building controls and still allows users to dim conference rooms /offices when required.

The interface to the building control uses a standard analog signal (0-10 v) or digital protocols which can be wired or wireless (e.g. zigbee, DALI, DMX). The building control signal is read to determine the maximum percentage dimming. The maximum set point established by the building control is compared to the phase dimming signal created by measurement of the AC waveform. In particular, the input AC signal is received as a half or full wave rectified signal. The rectified signal is placed thru a comparator set to the highest typical hold voltage for Triac dimmers. The square wave generated contains the dimming percentage as a width change on the waveform. This waveform is passed to the microcontroller U8, which is shown as being optically isolated from the circuit by opto-coupler U7. It should be understood by those of ordinary skill in the art having the present specification before them that microcontroller U8 may be non-isolated. Using this resulting waveform as an edge trigger microprocessor U8 counts the number of present timer intervals. This count is used to determine the phase diming.

The set point determined in from the building control is compared to the phase diming percentage count, whichever is lower is used to set the pulse width modulated diming. The building lighting control always maintains the peak illumination for both load shedding and occupancy time. The end points are where phase diming is 100% on and the building diming is 1%, here the AC-to-DC conversion is functioning normal with the feedback in control. The other extreme is the phase diming is 5% and the building diming is 100% on. For this the PWM needs to respond quickly to reduce the chance of LED flicker. Since the power in the AC mains may drop faster than the circuit can “dim-down” the circuit—using the averaging approach adopted in the circuitry—when the secondary bulk DC drops below an expected minimum voltage, the PWM moves to less than the phase angle value. Once the voltage recovers the LED will increase level to the percentage determined.

A local occupancy sensor can be another input as a switch toggle along with a local ambient light sensor. The occupancy toggle will define the PWM as max or off. Like the prior comparison this data can also be compared. The same is held for the light sensor which can also provide a signal that dims the led by providing the lowest diming percentage. An example of the hierarchal dimming working in a priority, the highest is the occupancy sensor, next phase diming, then ambient light and last building diming.

The ability to dim individual LED drivers exists but can create issues in fixtures where multiple LED drivers exist that can dim parts of fixtures. Where the dimming signal is digital, analog or phase diming the individual LED drivers may convert the dimming data provided into different LED drive currents where the result is each led segment can be at a different illumination level when diming occurs. This can occur with any of the dimming control method, the method with the most error is phase diming as this is not an absolute signal but a signal derived from the manipulation of the AC phase. To correct for this issue communication between LED drivers could be added at a fixture level to provides direct control over the LED drive current. This communication is the drive current data and not the higher level building data or phase data, as the drivers may be controlled by multiple dimming methods 0-10, DALI, Zigbee, Occupancy sensor, the LED drive current can be controlled at the lowest level with one driver determining the diming from one or multiple sources and the remaining driver listening and responding only.

The present system provides for the coordinated dimming throughout a room. The various driver circuits 1600 found on each light fixture are connected to each other via the ribbon cabling and connector J5. When the microprocessor U8 first powers up, it will look to see whether any other microprocessor has adopted the master role. If another microprocessor has taken the master role in the system, then the current microprocessor adopts the slave role, taking the calculation of dimming level from the master microprocessor. If no other microprocessor is sending the master signal, then microprocessor U8 will designate itself the master.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements, which, although not explicitly described or shown herein, embody the principles of the invention and, thus, are within its scope and spirit. All publication patents and patent applications described herein are incorporated by reference in their entirety.

1. A light source comprising:
a heat sink including a central cavity and at least one wall enclosing a portion of the central cavity;
a printed circuit board (PCB) disposed in the central cavity of the heat sink, the PCB having a driver circuit disposed on a first side of the PCB and a plurality of lamps substantially surface-mounted on an opposing side of the PCB, wherein the plurality of lamps are operably connected to the driver circuit, wherein each of the plurality of lamps is a semi-spherical solid state lamp, the PCB further having a connector that can be operably connected to a power source; and
a first optical structure in operable registration with at least one of the plurality of lamps.

2. The light source of claim 1, wherein the PCB further comprises two heat conducting strips proximate opposing edges of the PCB, wherein the plurality of lamps and the driver circuit are physically disposed on the PCB between the two heat conducting strips.

3. The light source of claim 2, further comprising a plurality of detachable heat conducting fasteners thermally connecting at least one of the two heat conducting strips to the heat sink.

4. The light source of claim 3, wherein the PCB further includes a plurality of holes disposed in a portion of at least one of the two heat conducting strips receiving the plurality of detachable heat conducting fasteners.

5. The light source of claim 1, wherein the first optical structure includes protrusions that mechanically connect the first optical structure to the PCB.

6. The light source of claim 1, wherein the first optical structure includes protrusions that establish a minimum fixed distance between the PCB and a surface of the first optical structure.

7. The light source of claim 1, further comprising a connector mechanically affixed to one end of the heat sink and physically extending therefrom such that when a second heat sink is placed in an abutting relationship with the heat sink the connector may be mechanically affixed to the second heat sink.

8. The light source of claim 7, wherein the connector comprises first and second mating components wherein the first and second mating components selectively and positively engage one another, one of the mating components being mechanically affixed to the heat sink.

9. The light source of claim 1, wherein the PCB includes at least one frangible section, each frangible section having at least one of the plurality of lamps substantially surface-mounted thereon and a pre-perforated border to facilitate breakaway of the frangible section from the PCB while allowing operable electrical connection between the at least one of the plurality of lamps and the driver circuit via a solid-state switch, the gate of the solid-state switch being biased into conduction by the voltage across the at least one of the plurality of lamps disposed on the frangible section.

10. The light source of claim 1, wherein further comprising a plurality of PCBs connected via male and female connectors formed in corresponding ends of each of the plurality of PCBs.

11. The light source of claim 10, wherein electrical components operatively connect the plurality of PCBs with one another through the central cavity of the heat sink, wherein a portion of the electrical components can be removably secured within the central cavity via at least one flange extending from the at least one wall of the heat sink.

12. The light source of claim 1, further comprising a second optical structure having a first optical element comprising a microdiffusion texture on a surface of the second optical structure.

13. The light source of claim 12, wherein the second optical structure is formed by injection molding and wherein the first optical element on the surface of the second optical structure is formed by the injection molding of the second optical structure.

14. The light source of claim 12, wherein the second optical structure further comprises a left protrusion and a right protrusion wherein the protrusions removably engage with corresponding left and right flanges extending from the at least one wall of the heat sink.

15. The light source of claim 14, further comprising at least one identifying mark on at least one of the left and right protrusions indicating a corresponding type of a second optical element.

16. The light source of claim 15, wherein the second optical element of the second optical structure provides an asymmetrical optical effect and the at least one identifying mark is deployed only on the left protrusion or the right protrusion respectively indicting a left direction or a right direction of the asymmetrical optical effect.

17. The light source of claim 1, wherein the number of lamps of the plurality of lamps connected to the driver is variable, wherein the last of the plurality of lamps is operably connected to the driver circuit via a solid-state switch forward biased by a voltage drop across one of the plurality of lamps.

18. The light source of claim 1, further comprising an optical structure for a plurality of lamps, wherein each lamp is a semi-spherical solid state lamp, wherein the optical structure emits substantially shadowless, substantially homogeneous, and substantially monochromatic light, the optical structure comprising:
a plurality of first optical elements, each associated with one of the plurality of lamps for substantially collimating the light emitted from the associated one of the plurality of lamps to form a substantially collimated beam; and
a second optical element associated with each of the plurality of first optical elements such that each of the plurality of second optical elements receives a portion of the substantially collimated beam and provides multiple optical images of the collimated beam, wherein the focal point of each of the multiple optical images formed by the plurality of second optical elements have a focal point that is practically infinite.

19. The light source of claim 18, the optical structure further comprising:
a third optical element molded onto an outer surface of the plurality of second optical elements, the third optical element comprising a microdiffusion pattern.

20. The light source of claim 18, wherein the practically infinite focal point of each of the multiple optical images is a focal point beyond the maximum distance at which the emitted light is visible.

21. The light source of claim 18, wherein the plurality of first optical elements, the plurality of second optical elements, and the third optical element are formed in a single injection molding process.

22. The light source of claim 18, wherein each of the plurality of second optical elements are disposed on a plane slanted towards a center axis of the optical structure.
